(19) United States
(12) Patent Application Publication
(10) Pub. No.: US 2014/0249269 A1
(43) Pub. Date: Sep. 4, 2014

(54) THERMALLY-DETACHABLE SHEET

(71) Applicant: NITTO DENKO CORPORATION, Ibaraki-shi, Osaka (JP)

(72) Inventors: Daisuke Uenda, Ibaraki-shi (JP); Yusuke Shirakawa, Ibaraki-shi (JP); Hiroshi Hamamoto, Ibaraki-shi (JP); Takashi Oda, Ibaraki-shi (JP); Eiji Toyoda, Ibaraki-shi (JP); Takeshi Matsumura, Ibaraki-shi (JP)

(21) Appl. No.: 14/348,947

(22) PCT Filed: Sep. 21, 2012
(86) PCT No.: PCT/JP2012/074143

§ 371 Date: Apr. 1, 2014

(30) Foreign Application Priority Data
Oct. 20, 2011 (JP) 2011-230937
Oct. 20, 2011 (JP) 2011-230938
Oct. 20, 2011 (JP) 2011-230941
Dec. 28, 2011 (JP) 2011-288609
Dec. 28, 2011 (JP) 2011-288624
Dec. 28, 2011 (JP) 2011-288631
Jun. 26, 2012 (JP) 2012-143287
Jun. 26, 2012 (JP) 2012-143288
Jun. 26, 2012 (JP) 2012-143292
Jun. 26, 2012 (JP) 2012-143315
Jun. 26, 2012 (JP) 2012-143320
Jun. 26, 2012 (JP) 2012-143322
Jun. 26, 2012 (JP) 2012-143326

(51) Int. Cl. C09D 177/06

(52) U.S. Cl. CPC C09D 177/06
USPC 524/726; 524/728

(57) ABSTRACT

In order to provide a thermally-detachable sheet that detaches at higher temperatures, this thermally-detachable sheet has a shear bond strength with respect to a silicon wafer of 0.25 kg/5×5 mm or larger, at a temperature of 200° C., after said temperature has been maintained for one minute, and a shear bond strength with respect to a silicon wafer of 0.25 kg/less than 5×5 mm at any temperature in a range of over 200° C. to not more than 500° C., after said temperature has been maintained for three minutes.

### TECHNICAL FIELD

The present invention relates to a thermally-detachable sheet.

### BACKGROUND ART

In the manufacturing and working processes of electronic components and the like, techniques such as temporary tacking of various materials and surface protection of a metal plate or the like have been conventionally performed, and a sheet member that is used for such purposes has been required to be able to be easily peeled off and removed from an adherend after serving for its purpose.

A heat-sensitive pressure-sensitive adhesive that can be peeled off by a heat treatment has been disclosed as such a sheet member (for example, refer to Patent Document 1). It is described in Patent Document 1 that the heat-sensitive pressure-sensitive adhesive can be used at a temperature up to 180° C.

### PRIOR ART DOCUMENT

### Patent Document

Patent Document 1: U.S. Pat. No. 7,202,107

### SUMMARY OF THE INVENTION

### Problems to be Solved by the Invention

As a first object, in recent years, a thermally-detachable sheet that exhibits a peeling property at a higher temperature has been desired. First and fourth aspects of the present invention are made in view of the above-described object, and an object thereof is to provide a thermally-detachable sheet that exhibits a peeling property at a higher temperature.

As a second object, in recent years, a thermally-detachable sheet that exhibits a peeling property at a higher temperature has been desired. On the other hand, when the heat-detachable sheet is used to manufacture a semiconductor device or the like, it is sometimes desirable that the heat-detachable sheet is peeled off from an adherend without being heated after being bonded to the adherend in consideration of damage to the wiring and protective film and melting of solder. A second aspect of the present invention is made in view of the above-described object, and an object thereof is to provide a solvent-detachable sheet that can be easily peeled off using a solvent.

As a third object, in recent years, a thermally-detachable sheet that has higher heat resistance has been desired. The present invention is made in view of the above-described object, and an object thereof is to provide a thermally-detachable sheet having higher heat resistance.

As a fourth object, in recent years, a thermally-detachable sheet that does not deteriorate at a higher temperature has been desired. A fifth aspect of the present invention is made in view of the above-described object, and an object thereof is to provide a thermally-detachable sheet having excellent durability at a high temperature.

As a fifth object, in recent years, a thermally-detachable sheet that exhibits a peeling property at a higher temperature and whose peeling temperature is controllable has been desired. A sixth aspect of the present invention is made in view of the above-described object, and an object thereof is to provide a thermally-detachable sheet that exhibits a peeling property at a higher temperature and whose peeling temperature is controllable.

As a sixth object, in recent years, a thermally-detachable sheet, that is not peeled off even when being exposed to a relatively high temperature under the condition of a low oxygen concentration, and that is peeled off at a relatively low temperature in a condition in which the oxygen concentration is at the same level as that of the atmosphere compared to the temperature in the condition of a low oxygen concentration, has been desired. A seventh aspect of the present invention is made in view of the above-described object, and an object thereof is to provide a thermally-detachable sheet that is not peeled off even when being exposed to a relatively high temperature under the condition of a low oxygen concentration, and that exhibits a peeling property at a relatively low temperature in a condition in which the oxygen concentration is at the same level as that of the atmosphere compared to the temperature in the condition of a low oxygen concentration.

As a seventh object, the present inventors have already invented a method of manufacturing a semiconductor device having a configuration (1) described below (for example, refer to JP-A-2010-141126).

(1) A method of manufacturing a semiconductor device having a structure in which a semiconductor chip is mounted on a wiring circuit board, including the steps of forming the wiring circuit board having a conductor portion for connection to an electrode on the semiconductor chip so that the wiring circuit board can be peeled off from the support layer and the conductor portion for connection is exposed to an upper surface of the wiring circuit board, connecting the conductor portion for connection of the wiring circuit board to the electrode of the semiconductor chip to mount the semiconductor chip on the wiring circuit board, and peeling the metallic support layer from the wiring circuit board after the mounting, in which a release layer is formed between the metallic support layer and the wiring circuit board to enable the wiring circuit board to be peeled off from the metallic support layer.

According to the configuration (1), after the chip is mounted on the wiring circuit board, the metallic support layer can be peeled and removed without etching, and the metallic support layer can be reused to reduce manufacturing cost. In addition, deformation of the wiring circuit board that lies directly under the semiconductor chip to be mounted can be prevented due to rigidity (stiffness) of the metallic support layer.

When the above-described method of manufacturing a semiconductor device is adopted, first, the wiring circuit board should be formed on a support. However, the wiring circuit board receives a thermal history of a relatively high temperature multiple times in the step of forming the wiring circuit board. Because of that, higher heat resistance is required for the release layer. In addition, a characteristic of being peeled off is required after the semiconductor chip is mounted on the wiring circuit board.

As an eighth object, if the above-described method of manufacturing a semiconductor device is adopted, first, a wiring circuit board should be formed on the support. In the step of forming the wiring circuit board, it is necessary that the wiring circuit board does not peel from the metallic support layer. On the other hand, after the wiring circuit board is formed, it is sometimes desirable to peel off the metallic support layer without heating in consideration of damage to the wiring and the like.

### Means for Solving the Problems

The present inventors found that the above-described objects can be achieved by adopting the following configuration, and completed the present invention.

For the first object, the thermally-detachable sheet according to the first aspect of the present invention is characterized in that the shear adhering strength of the thermally-detachable sheet to a silicon wafer at 200° C. after the sheet is kept at that temperature for 1 min is 0.25 kg/5×5 mm or more, and that the shear adhering strength of the thermally-detachable sheet to a silicon wafer at any temperature in a temperature range of more than 200° C. and 500° C. or less after the sheet is kept at that temperature for 3 min is less than 0.25 kg/5×5 mm.

According to the thermally-detachable sheet according to the first aspect of the present invention, the shear adhering strength of the thermally-detachable sheet to a silicon wafer at 200° C. after the sheet is kept at that temperature for 1 min is 0.25 kg/5×5 mm or more, and the shear adhering strength of the thermally-detachable sheet to a silicon wafer at any temperature in a temperature range of more than 200° C. and 500° C. or less after the sheet is kept at that temperature for 3 min is less than 0.25 kg/5×5 mm. Therefore, the thermally-detachable sheet has a certain level of tackiness at 200° C., and exhibits a higher peeling property at a temperature higher than 200° C. than the peeling property exhibited at 200° C. As described above, according to the first aspect of the present invention, a thermally-detachable sheet that exhibits a peeling property at a higher temperature can be provided.

In the above-described configuration, the dynamic hardness is preferably 10 or less. When the dynamic hardness is 10 or less, the adhering strength of the thermally-detachable sheet to an adherend can be made sufficient.

In the above-described configuration, the weight loss rate of the thermally-detachable sheet after the sheet is soaked in a 3% aqueous tetramethyl ammonium hydroxide solution for 5 min is preferably less than 1% by weight. When the weight loss rate of the thermally-detachable sheet after the sheet is soaked in a 3% aqueous tetramethyl ammonium hydroxide solution for 5 min is less than 1% by weight, less elution of the thermally-detachable sheet into the 3% aqueous tetramethyl ammonium hydroxide solution occurs. Therefore, solvent resistance (especially, solvent resistance to an aqueous tetramethyl ammonium hydroxide solution) can be improved.

In the above-described configuration, the increased amount of particles of 0.2 μm or more on a surface of a silicon wafer when the thermally-detachable sheet is bonded to the silicon wafer and then peeled off is preferably less than 10,000 particles/6 inch wafer with respect to the amount before the sheet is bonded to the silicon wafer. When the increased amount of particles of 0.2 μm or more on the surface of a silicon wafer when the thermally-detachable sheet is bonded to the silicon wafer and then peeled off is less than 10,000 particles/6 inch wafer with respect to the amount before the sheet is bonded to the silicon wafer, adhesive residue after peeling can be suppressed.

In addition, the thermally-detachable sheet with a support of the first aspect of the present invention is characterized in that the thermally-detachable sheet is provided on a support in order to achieve the above-described object.

For the second object, the solvent-detachable sheet according to the second aspect of the present invention is characterized in that the weight loss rate of the solvent-detachable sheet after the sheet is soaked in N-methyl-2-pyrrolidone at 50° C. for 60 sec and dried at 150° C. for 30 min is 1.0% by weight or more.

According to the solvent-detachable sheet according to the second aspect of the present invention, the weight loss rate of the solvent-detachable sheet after the sheet is soaked in N-methyl-2-pyrrolidone (NMP) at 50° C. for 60 sec and dried at 150° C. for 30 min is 1.0% by weight or more. The weight loss rate of the solvent-detachable sheet after the sheet is soaked in N-methyl-2-pyrrolidone (NMP) at 50° C. for 60 sec and dried at 150° C. for 30 min is 1.0% by weight or more. Therefore, the solvent-detachable sheet is eluted in N-methyl-2-pyrrolidone and a sufficient weight loss can be achieved. As a result, the solvent-detachable sheet can be easily peeled off by using N-methyl-2-pyrrolidone. The weight loss rate of the solvent-detachable sheet can be controlled by the solubility of the raw material of the solvent-detachable sheet in NMP. That is, the higher the solubility of the selected raw material in NMP is, the higher the solubility of the solvent-detachable sheet obtained using the selected raw material in NMP becomes.

In the above-described configuration, the dynamic hardness is preferably 10 or less. When the dynamic hardness is 10 or less, the adhering strength of the solvent-detachable sheet to an adherend can be made sufficient.

In the above-described configuration, the weight loss rate of the thermally-detachable sheet after the sheet is soaked in a 3% aqueous tetramethyl ammonium hydroxide solution for 5 min is preferably less than 1% by weight. When the weight loss rate of the thermally-detachable sheet after the sheet is soaked in a 3% aqueous tetramethyl ammonium hydroxide solution for 5 min is less than 1% by weight, less elution of the thermally-detachable sheet into the 3% aqueous tetramethyl ammonium hydroxide solution occurs. Therefore, solvent resistance (especially, solvent resistance to an aqueous tetramethyl ammonium hydroxide solution) can be improved.

In the above-described configuration, the increased amount of particles of 0.2 μm or more on a surface of a silicon wafer when the thermally-detachable sheet is bonded to the silicon wafer and then peeled off is preferably less than 10,000 particles/6 inch wafer with respect to the amount before the sheet is bonded to the silicon wafer. When the increased amount of particles of 0.2 μm or more on the surface of a silicon wafer when the thermally-detachable sheet is bonded to the silicon wafer and then peeled off is less than 10,000 particles/6 inch wafer with respect to the amount before the sheet is bonded to the silicon wafer, adhesive residue after peeling can be suppressed.

In addition, the solvent-detachable sheet with a support of the second aspect of the present invention is characterized in that the solvent-detachable sheet is provided on a support in order to achieve the above-described object.

For the third object, the thermally-detachable sheet according to the third aspect of the present invention is characterized in that it has an imide group.

According to the thermally-detachable sheet according to the third aspect of the present invention, it has excellent heat resistance because it has an imide group. Whether or not the thermally-detachable sheet has an imide group can be confirmed by whether or not a spectrum having an absorption peak at 1,400 cm⁻¹ to 1,500 cm⁻¹ exists in the FT-IR (fourier transform infrared spectroscopy) spectrum. That is, when there is a spectrum having an absorption peak at 1,400 cm⁻¹ to 1,500 cm⁻¹, the thermally-detachable sheet is determined to have an imide group.

In the above-described configuration, the thermally-detachable sheet preferably has a constituent unit derived from a diamine having an ether structure. When the thermally-detachable sheet has a constituent unit derived from a diamine having an ether structure, the thermally-detachable sheet can be heated to a high temperature (for example, 200° C. or more) to decrease the shear adhering strength. The present inventors make an assumption on this phenomenon that the ether structure is eliminated from the resin that constitutes the thermally-detachable sheet when the sheet is heated to a high temperature, and the shear adhering strength decreases due to this elimination.

Whether or not the thermally-detachable sheet has a diamine having an ether structure can be confirmed by whether or not a spectrum having an absorption peak at 2,700 cm⁻¹ to 3,000 cm⁻¹ exists in the FT-IR (fourier transform infrared spectroscopy) spectrum. That is, when there is a spectrum having an absorption peak at 2,700 cm⁻¹ to 3,000 cm⁻¹, the thermally-detachable sheet is determined to have a diamine having an ether structure.

Further, the elimination of the ether structure from the resin that constitutes the thermally-detachable sheet can be confirmed by comparing the FT-IR (fourier transform infrared spectroscopy) spectra before and after the thermally-detachable sheet is heated at 300° C. for 30 min and confirming the decrease of the spectrum at 2,800 cm⁻¹ to 3,000 cm⁻¹ after the heating.

In the above-described configuration, the constituent unit derived from a diamine having an ether structure preferably has a glycol skeleton or a glycol skeleton derived from a diamine having alkylene glycol. When the constituent unit derived from a diamine having an ether structure has a glycol skeleton or a glycol skeleton derived from a diamine having alkylene glycol, a better peeling property is exhibited when the thermally-detachable sheet is heated to a high temperature (for example, 200° C. or more).

Whether or not the thermally-detachable sheet has a diamine having a glycol skeleton can be confirmed by whether or not a spectrum having an absorption peak at 2,700 cm⁻¹ to 3,000 cm⁻¹ exists in the FT-IR spectrum. That is, when there is a spectrum having an absorption peak at 2,700 cm⁻¹ to 3,000 cm⁻¹, the thermally-detachable sheet is determined to have a diamine having a glycol skeleton.

Especially, whether or not the thermally-detachable sheet has a diamine having a glycol skeleton derived from a diamine having alkylene glycol can be confirmed by whether or not a spectrum having an absorption peak at 2,700 cm⁻¹ to 3,000 cm⁻¹ exists in the FT-IR spectrum.

In the above-described configuration, the constituent material of the thermally-detachable sheet is preferably a polyimide resin that is obtained by imidizing polyamic acid obtained by reacting an acid anhydride, a diamine having an ether structure, and a diamine having no ether structure, and the compounding ratio of a diamine having an ether structure to a diamine having no ether structure is preferably in a range of 100:0 to 10:90 by mole ratio when reacting the acid anhydride, the diamine having an ether structure, and the diamine having no ether structure. When the compounding ratio of a diamine having an ether structure to a diamine having no ether structure is in a range of 100:0 to 10:90 by mole ratio when reacting the acid anhydride, the diamine having an ether structure, and the diamine having no ether structure, a superior thermal peeling property at a high temperature can be obtained.

In the above-described configuration, the molecular weight of the diamine having an ether structure is preferably in a range of 200 to 5,000. The molecular weight of the diamine having an ether structure is measured by GPC (gel permeation chromatography), and is a value (weight average molecular weight) calculated by polystyrene conversion.

In addition, the thermally-detachable sheet with a support of the third aspect of the present invention is characterized in that the thermally-detachable sheet is provided on a support in order to achieve the above-described object.

For the first object, the thermally-detachable sheet according to the fourth aspect of the present invention is characterized in that it does not substantially contain a foaming agent, that its shear adhering strength to a silicon wafer at any temperature in a temperature range of 200° C. or less after the sheet is kept at that temperature for 1 min is 0.25 kg/5×5 mm or more and that its shear adhering strength to a silicon wafer at any temperature in a temperature range of more than 200° C. and 500° C. or less after the sheet is kept at that temperature for 3 min is less than 0.25 kg/5×5 mm.

According to the thermally-detachable sheet according to the fourth aspect of the present invention, the shear adhering strength of the thermally-detachable sheet to a silicon wafer at any temperature in a temperature range of 200° C. or less after the sheet is kept at that temperature for 1 min is 0.25 kg/5×5 mm or more and the shear adhering strength of the thermally-detachable sheet to a silicon wafer at any temperature in a temperature range of more than 200° C. and 500° C. or less after the sheet is kept at that temperature for 3 min is less than 0.25 kg/5×5 mm. Therefore, when the thermally-detachable sheet is kept at any temperature in a temperature range of more than 200° C. and 500° C. or less for 3 min, the shear adhering strength decreases compared to when it is kept at any temperature in a temperature range of 200° C. or less for 1 min. In addition, because the thermally-detachable sheet does not substantially contain a foaming agent, it is excellent in respect of absence of contamination, especially absence of contamination with metals that are generated from a foaming agent. That is, problems of migration originated from metal contamination and corrosion are less likely to occur.

As described above, according to the fourth aspect of the present invention, a thermally-detachable sheet that exhibits a peeling property at a higher temperature in a state in which the thermally-detachable sheet does not substantially contain a foaming agent can be provided.

In the above-described configuration, the content of the foaming agent is preferably 0.1% by weight or less.

For the fourth object, the thermally-detachable sheet according to the fifth aspect of the present invention is characterized in that the thermal curing rate is 80% or more.

The thermal curing rate of the thermally-detachable sheet according to the fifth aspect of the present invention is 80% or more. Therefore, further thermal curing hardly occurs when the sheet is used in a high temperature environment. As a result, the thermally-detachable sheet has excellent durability at high temperature. The thermal curing rate is obtained by measuring the amount of heat generation using DSC (differential scanning calorimetry). The specific method is described in detail later.

Further, the thermally-detachable sheet according to the fifth aspect of the present invention contains a polyimide resin, and has an imidization rate of 80% or more. Therefore, further imidization hardly occurs when the thermally-detachable sheet is used in a high temperature environment. As a result, the thermally-detachable sheet has excellent durability at high temperature. The imidization rate is obtained by measuring a peak intensity of an imide group using 1H-NMR (proton nuclear magnetic resonance). The specific method is described in detail later.

For the fifth object, the thermally-detachable sheet according to the sixth aspect of the present invention is characterized in that its shear adhering strength to a silicon wafer at any temperature in a temperature range of 200° C. or less after the sheet is kept at that temperature for 1 min is 0.25 kg/5×5 mm or more, that its shear adhering strength to a silicon wafer at any temperature in a temperature range of more than 200° C. and 500° C. or less after the sheet is kept at that temperature for 3 min is less than 0.25 kg/5×5 mm, and that the ratio of the constituent unit derived from a diamine having an ether structure to the constituent unit derived from another diamine having no ether structure is 10:90 to 70:30 by mole ratio.

According to the thermally-detachable sheet according to the sixth aspect of the present invention, the shear adhering strength of the thermally-detachable sheet to a silicon wafer at any temperature in a temperature range of 200° C. or less after the sheet is kept at that temperature for 1 min is 0.25 kg/5×5 mm or more and that the shear adhering strength of the thermally-detachable sheet to a silicon wafer at any temperature in a temperature range of more than 200° C. and 500° C. or less after the sheet is kept at that temperature for 3 min is less than 0.25 kg/5×5 mm. Therefore, when the thermally-detachable sheet is kept at any temperature in a temperature range of more than 200° C. and 500° C. or less for 3 min, the shear adhering strength decreases compared to when it is kept at any temperature in a temperature range of 200° C. or less for 1 min.

In addition, because the ratio of the constituent unit derived from a diamine having an ether structure to the constituent unit derived from another diamine having no ether structure is 10:90 to 70:30 by mole ratio, the shear adhering strength to a silicon wafer can be suitably controlled. Specifically, when the ratio of the constituent unit derived from a diamine having an ether structure is increased in the above-described range of mole ratio and the thermally-detachable sheet is kept at a relatively low temperature in a temperature range higher than 200° C. (for example, 200° C. to 250° C.) for 3 min, the shear adhering strength can be decreased (to less than 0.25 kg/5×5 mm). Further, when the ratio of the constituent unit derived from a diamine having an ether structure is decreased and the thermally-detachable sheet is not kept at a relatively high temperature in a temperature range higher than 200° C. (for example, 250° C. to 400° C.) for 3 min, a decrease of the shear adhering strength (to less than 0.25 kg/5×5 mm) can be avoided.

As described above, according to the sixth aspect of the present invention, a thermally-detachable sheet that exhibits a peeling property at a higher temperature and whose peeling temperature can be controlled can be provided.

For the sixth object, the thermally-detachable sheet according to the seventh aspect of the present invention is characterized in that

the shear adhering strength of the thermally-detachable sheet to a silicon wafer after the sheet is kept at any temperature in a temperature range of more than 200° C. and 400° C. or less for 0.1 min to 60 min under a condition in which the oxygen concentration is 100 ppm or less is 0.25 kg/5×5 mm or more; and

the shear adhering strength of the thermally-detachable sheet to a silicon wafer after the sheet is kept at any temperature in a temperature range of 50° C. or more and 300° C. or less for 1 min to 30 min under an atmospheric pressure condition in which the oxygen concentration is 18% to 25% is less than 0.25 kg/5×5 mm.

According to the thermally-detachable sheet according to the seventh aspect of the present invention, because the shear adhering strength of the thermally-detachable sheet to a silicon wafer after the sheet is kept at any temperature in a temperature range of more than 200° C. and 400° C. or less for 0.1 min to 60 min under a condition in which the oxygen concentration is 100 ppm or less is 0.25 kg/5×5 mm or more, the thermally-detachable sheet is not peeled off even if it is exposed to a relatively high temperature. On the other hand, because the shear adhering strength of the thermally-detachable sheet to a silicon wafer after the sheet is kept at any temperature in a temperature range of 50° C. or more and 300° C. or less for 1 min to 30 min under an atmospheric pressure condition in which the oxygen concentration is 18% to 25% is less than 0.25 kg/5×5 mm, the thermally-detachable sheet is peeled off at a lower temperature in the condition in which the oxygen concentration is at the same level as that of the atmosphere compared to the condition in which the oxygen concentration is low.

For the seventh object, the method of manufacturing a semiconductor device according to the eighth aspect of the present invention is a method of manufacturing a semiconductor device having a structure in which a semiconductor chip is mounted on a wiring circuit board, including the steps of:

preparing a support having a release layer,

forming a wiring circuit board on the release layer of the support,

mounting a semiconductor chip to the wiring circuit board, and

peeling the support off together with the release layer after the mounting with a surface of the release layer opposite to the support as an interface, characterized in that

the shear adhering strength of the release layer to a silicon wafer at 200° C. after the sheet is kept at that temperature for 1 min is 0.25 kg/5×5 mm or more, and the shear adhering strength of the release layer to a silicon wafer at any temperature in a temperature range of more than 200° C. and 500° C. or less after the sheet is kept at that temperature for 3 min is less than 0.25 kg/5×5 mm.

According to the above-described configuration, the shear adhering strength of the release layer to a silicon wafer at 200° C. after the sheet is kept at that temperature for 1 min is 0.25 kg/5×5 mm or more, and the shear adhering strength of the release layer to a silicon wafer at any temperature in a temperature range of more than 200° C. and 500° C. or less after the sheet is kept at that temperature for 3 min is less than 0.25 kg/5×5 mm. Therefore, the release layer is not peeled off even when it is exposed to a comparatively high temperature, and it is peeled off at a temperature in a still higher temperature range. As a result, the support and the wiring circuit board are made not to be peeled away from each other when the wiring circuit board is formed on the support, and they can be peeled away from each other after the semiconductor chip is mounted on the wiring circuit board.

In the above-described configuration, the dynamic hardness of the release layer is preferably 10 or less. When the dynamic hardness is 10 or less, the adhering strength of the release layer to an adherend (the support and the wiring circuit board) can be made sufficient.

In the above-described configuration, the weight loss rate of the release layer after the sheet is soaked in a 3% aqueous tetramethyl ammonium hydroxide solution for 5 min is preferably less than 1% by weight. When the weight loss rate of the thermally-detachable sheet after the sheet is soaked in a 3% aqueous tetramethyl ammonium hydroxide solution for 5 min is less than 1% by weight, less elution of the thermally-detachable sheet into the 3% aqueous tetramethyl ammonium hydroxide solution occurs. Therefore, solvent resistance (especially, solvent resistance to an aqueous tetramethyl ammonium hydroxide solution) can be improved.

In the above-described configuration, the increased amount of particles of 0.2 μm or more on the surface of a silicon wafer when the release layer is bonded to the silicon wafer and then peeled off is preferably less than 10,000 particles/6 inch wafer with respect to the amount before the sheet is bonded to the silicon wafer. When the increased amount of particles of 0.2 μm or more on the surface of a silicon wafer when the thermally-detachable sheet is bonded to the silicon wafer and then peeled off is less than 10,000 particles/6 inch wafer with respect to the amount before the sheet is bonded to the silicon wafer, adhesive residue after peeling can be suppressed.

For the eighth object, the method of manufacturing a semiconductor device according to a ninth aspect of the present invention is a method of manufacturing a semiconductor device having a structure in which a semiconductor chip is mounted on a wiring circuit board, including the steps of:

preparing a support having a release layer,

forming a wiring circuit board on the release layer of the support,

mounting a semiconductor chip to the wiring circuit board, and

peeling the support off together with the release layer after the mounting with a surface of the release layer opposite to the support as an interface, characterized in that

the weight loss rate of the release layer after the sheet is soaked in N-methyl-2-pyrrolidone at 50° C. for 60 sec and dried at 150° C. for 30 min is 1.0% by weight or more.

According to the above-described configuration, the weight loss rate of the release layer after the sheet is soaked in N-methyl-2-pyrrolidone (NMP) at 50° C. for 60 sec and dried at 150° C. for 30 min is 1.0% by weight or more. Because the weight loss rate of the release layer after the sheet is soaked in N-methyl-2-pyrrolidone (NMP) at 50° C. for 60 sec and dried at 150° C. for 30 min is 1.0% by weight or more, the release layer is eluted into N-methyl-2-pyrrolidone, and the weight is sufficiently decreased. As a result, the release layer can be easily peeled off by using N-methyl-2-pyrrolidone. Therefore, according to the above-described configuration, the support can be peeled off together with the release layer using NMP without heating after the wiring circuit board is formed. The weight loss rate of the release layer can be controlled by the solubility of the raw material of the release layer in NMP. That is, the higher the solubility of the selected raw material in NMP is, the higher the solubility of the release layer obtained using the selected raw material in NMP becomes.

In the above-described configuration, the dynamic hardness of the release layer is preferably 10 or less. When the dynamic hardness is 10 or less, the adhering strength of the release layer to an adherend (the support and the wiring circuit board) can be made sufficient.

In the above-described configuration, the weight loss rate of the release layer after the sheet is soaked in a 3% aqueous tetramethyl ammonium hydroxide solution for 5 min is preferably less than 1% by weight. When the weight loss rate of the thermally-detachable sheet after the sheet is soaked in a 3% aqueous tetramethyl ammonium hydroxide solution for 5 min is less than 1% by weight, less elution of the thermally-detachable sheet into the 3% aqueous tetramethyl ammonium hydroxide solution occurs. Therefore, solvent resistance (especially, solvent resistance to an aqueous tetramethyl ammonium hydroxide solution) can be improved.

In the above-described configuration, the increased amount of particles of 0.2 μm or more on the surface of a silicon wafer when the release layer is bonded to the silicon wafer and then peeled off is preferably less than 10,000 particles/6 inch wafer with respect to the amount before the sheet is bonded to the silicon wafer. When the increased amount of particles of 0.2 μm or more on the surface of a silicon wafer when the thermally-detachable sheet is bonded to the silicon wafer and then peeled off is less than 10,000 particles/6 inch wafer with respect to the amount before the sheet is bonded to the silicon wafer, adhesive residue after peeling can be suppressed.

For the seventh object, the method of manufacturing a semiconductor device according to a tenth aspect of the present invention is a method of manufacturing a semiconductor device having a structure in which a semiconductor chip is mounted on a wiring circuit board, including the steps of:

preparing a support having a release layer, forming a wiring circuit board on the release layer of the support,

mounting a semiconductor chip to the wiring circuit board, and

peeling the support off together with the release layer after the mounting with a surface of the release layer opposite to the support as an interface, characterized in that

the release layer has an imide group and at least a portion of the release layer has a constituent unit derived from a diamine having an ether structure.

According to the above-described configuration, the release layer has excellent heat resistance because it has the imide group. Whether or not the release layer has an imide group can be confirmed by whether or not a spectrum having an absorption peak at 1,400 cm⁻¹ to 1,500 cm⁻¹ exists in the FT-IR (fourier transform infrared spectroscopy) spectrum. That is, when there is a spectrum having an absorption peak at 1,400 cm⁻¹ to 1,500 cm⁻¹, the thermally-detachable sheet is determined to have an imide group.

Because the release layer has a constituent unit derived from a diamine having an ether structure, the release layer can be heated to decrease the shear adhering strength. The present inventors make an assumption on this phenomenon that the ether structure is eliminated from the resin that constitutes the release layer when it is heated, and the shear adhering strength decreases due to this elimination.

Whether or not the release layer has a diamine having an ether structure can be confirmed by whether or not a spectrum having an absorption peak at 2,700 cm⁻¹ to 3,000 cm⁻¹ exists in the FT-IR (fourier transform infrared spectroscopy) spectrum. That is, when there is a spectrum having an absorption peak at 2,700 cm⁻¹ to 3,000 cm⁻¹, the release layer is determined to have a diamine having an ether structure.

Further, the elimination of the ether structure from the resin that constitutes the release layer can be confirmed by comparing the FT-IR (fourier transform infrared spectroscopy) spectra before and after the release layer is heated at 300° C. for 30 min and confirming the decrease of the spectrum at 2,800 cm⁻¹ to 3,000 cm⁻¹ after the heating.

As described above, according to the above-described configuration, the release layer has higher heat resistance, and has a peeling property at a higher temperature. As a result, the support and the wiring circuit board are made not to be peeled away from each other when the wiring circuit board is formed on the support, and they can be peeled away from each other after the semiconductor chip is mounted on the wiring circuit board.

In the above-described configuration, the constituent unit derived from a diamine having an ether structure preferably has a glycol skeleton or a glycol skeleton derived from a diamine having alkylene glycol. When the constituent unit derived from a diamine having an ether structure has a glycol skeleton or a glycol skeleton derived from a diamine having alkylene glycol, a better peeling property is exhibited when the release layer is heated.

Whether or not the release layer has a diamine having a glycol skeleton can be confirmed by whether or not a spectrum having an absorption peak at 2,700 cm⁻¹ to 3,000 cm⁻¹ exists in the FT-IR spectrum. That is, when there is a spectrum having an absorption peak at 2,700 cm⁻¹ to 3,000 cm⁻¹, the thermally-detachable sheet is determined to have a diamine having a glycol skeleton.

Especially, whether or not the release layer has a diamine having a glycol skeleton derived from a diamine having alkylene glycol can be confirmed by whether or not a spectrum having an absorption peak at 2,700 cm⁻¹ to 3,000 cm⁻¹ exists in the FT-IR spectrum.

In the above-described configuration, the constituent material of the release layer is a polyimide resin that is obtained by imidizing polyamic acid obtained by reacting an acid anhydride, a diamine having an ether structure, and a diamine having no ether structure, and the compounding ratio of a diamine having an ether structure to a diamine having no ether structure is preferably in a range of 100:0 to 10:90 by mole ratio when reacting the acid anhydride, the diamine having an ether structure, and the diamine having no ether structure. When the compounding ratio of a diamine having an ether structure to a diamine having no ether structure is in a range of 100:0 to 10:90 by mole ratio when reacting the acid anhydride, the diamine having an ether structure, and the diamine having no ether structure, a superior thermal peeling property at a high temperature can be obtained.

In the above-described configuration, the molecular weight of the diamine having an ether structure is preferably in a range of 200 to 5,000. The molecular weight of the diamine having an ether structure is measured by GPC (gel permeation chromatography), and is a value (weight average molecular weight) calculated by polystyrene conversion.

### Effect of the Invention

According to the first and fourth aspects of the present invention, a thermally-detachable sheet that exhibits a peeling property at a higher temperature and a support with a thermally-detachable sheet in which the thermally-detachable sheet is provided on the support can be provided.

According to the second aspect of the present invention, a solvent-detachable sheet that can be easily peeled off using a solvent and a support with a solvent-detachable sheet in which the solvent-detachable sheet is provided on the support can be provided.

According to the third aspect of the present invention, a thermally-detachable sheet that exhibits a higher heat resistance and a support with a thermally-detachable sheet in which the thermally-detachable sheet is provided on the support can be provided.

According to the fifth aspect of the present invention, a thermally-detachable sheet having excellent durability at a high temperature can be provided.

According to the sixth aspect of the present invention, a thermally-detachable sheet that exhibits a peeling property at a higher temperature and whose peeling temperature can be controlled can be provided.

According to the seventh aspect of the present invention, a thermally-detachable sheet can be provided that is not peeled off even when being exposed to a relatively high temperature under the condition of a low oxygen concentration, and that exhibits a peeling property at a relatively low temperature in a condition in which the oxygen concentration is at the same level as that of the atmosphere compared to the temperature in the condition of a low oxygen concentration.

According to the eighth and tenth aspects of the present invention, a method of manufacturing a semiconductor device can be provided, in which the support and the wiring circuit board can be made not to be peeled away from each other when the wiring circuit board is formed on the support, and they can be peeled away from each other after the semiconductor chip is mounted on the wiring circuit board.

According to the ninth aspect of the present invention, a method of manufacturing a semiconductor device can be provided, in which the support can be peeled off together with the release layer without heating after the wiring circuit board is formed.

### BRIEF DESCRIPTION OF THE DRAWINGS

FIG. 1 is a schematic cross-sectional diagram for illustrating an outline of the method of manufacturing a semiconductor device according to one embodiment of an eighth aspect of the present invention.

FIG. 2 is a schematic cross-sectional diagram for illustrating an outline of the method of manufacturing a semiconductor device according to one embodiment of the eighth aspect of the present invention.

FIG. 3 is a schematic cross-sectional diagram for illustrating an outline of the method of manufacturing a semiconductor device according to one embodiment of the eighth aspect of the present invention.

FIG. 4 is a schematic cross-sectional diagram for illustrating in detail one example of the method of manufacturing a semiconductor device shown in FIG. 3.

FIG. 5 is a schematic cross-sectional diagram for illustrating in detail one example of the method of manufacturing the semiconductor device shown in FIG. 3.

FIG. 6 is a schematic cross-sectional diagram for illustrating in detail one example of the method of manufacturing the semiconductor device shown in FIG. 3.

FIG. 7 is a schematic cross-sectional diagram for illustrating in detail one example of the method of manufacturing the semiconductor device shown in FIG. 3.

FIG. 8 is a schematic cross-sectional diagram for illustrating in detail one example of the method of manufacturing the semiconductor device shown in FIG. 3.

FIG. 9 is a schematic cross-sectional diagram for illustrating in detail one example of the method of manufacturing the semiconductor device shown in FIG. 3.

FIG. 10 is a schematic cross-sectional diagram for illustrating in detail one example of the method of manufacturing the semiconductor device shown in FIG. 3.

FIG. 11 is a schematic cross-sectional diagram for illustrating in detail one example of the method of manufacturing the semiconductor device shown in FIG. 3.

### MODE FOR CARRYING OUT THE INVENTION

### First Aspect of the Present Invention

The shear adhering strength of the thermally-detachable sheet of the first aspect of the present invention to a silicon wafer at 200° C. after the sheet is kept at that temperature for 1 min is 0.25 kg/5×5 mm or more, preferably 0.30 kg/5×5 mm or more, and more preferably 0.50 kg/5×5 mm or more. Further, the shear adhering strength of the thermally-detachable sheet to a silicon wafer at any temperature in a temperature range of more than 200° C. and 500° C. or less after the sheet is kept at that temperature for 3 min is less than 0.25 kg/5×5 mm, preferably less than 0.10 kg/5×5 mm, and more preferably less than 0.05 kg/5×5 mm. Because the shear adhering strength of the thermally-detachable sheet to a silicon wafer at 200° C. after the sheet is kept at that temperature for 1 min is 0.25 kg/5×5 mm or more and the shear adhering strength of the thermally-detachable sheet to a silicon wafer at any temperature in a temperature range of more than 200° C. and 500° C. or less after the sheet is kept at that temperature for 3 min is less than 0.25 kg/5×5 mm, the thermally-detachable sheet has a certain level of tackiness at 200° C., and it exhibits a higher peeling property at a temperature higher than 200° C. than the peeling property exhibited at 200° C. As a result, according to the thermally-detachable sheet of the first aspect of the present invention, a thermally-detachable sheet that exhibits a peeling property at a higher temperature can be provided. The shear adhering strength of the thermally-detachable sheet can be controlled by the number of functional groups included in the thermally-detachable sheet, for example.

In addition, the temperature at which the shear adhering strength of the thermally-detachable sheet to a silicon wafer becomes less than 0.25 kg/5×5 mm (preferably, less than 0.10 kg/5×5 mm, and more preferably less than 0.05 kg/5×5 mm) is not especially limited as long as it is any temperature in a temperature range of more than 200° C. and 500° C. or less. However, it is preferably more than 220° C. and 480° C. or less, and more preferably more than 240° C. and 450° C. or less.

The shear adhering strength of the thermally-detachable sheet to a silicon wafer may become less than 0.25 kg/5×5 mm even at 200° C. or less when the sheet is kept for a long time (for example, 30 min or more). Further, the shear adhering strength of the thermally-detachable sheet to a silicon wafer may not become less than 0.25 kg/5×5 mm if the sheet is kept for a short time (for example, within 0.1 min) even when the sheet is kept at a temperature higher than 200° C. (for example, 210° C. to 400° C.).

That is, “the shear adhering strength to a silicon wafer at any temperature in a temperature range of more than 200° C. and 500° C. or less after the sheet is kept at that temperature for 3 min is less than 0.25 kg/5×5 mm” is an indicator for evaluating the peeling property at a high temperature, and it does not mean that the shear adhering strength to a silicon wafer necessarily becomes less than 0.25 kg/5×5 mm when the temperature is “any temperature in a temperature range of more than 200° C. and 500° C. or less”. Also, it does not mean that the peeling property cannot be exhibited unless the temperature is “any temperature in a temperature range of more than 200° C. and 500° C. or less”.

The dynamic hardness of the thermally-detachable sheet is preferably 10 or less, more preferably 9 or less, and further preferably 8 or less. The smaller the dynamic hardness is, the more preferable it is. However, it is 0.001 or more, for example. When the dynamic hardness is 10 or less, the adhering strength of the thermally-detachable sheet to an adherend can be made sufficient.

The surface hardness of the thermally-detachable sheet is preferably 10 GPa or less, more preferably 8 GPa or less, and further preferably 6 GPa or less. The smaller the surface hardness is, the more preferable it is. However, it is 0.05 GPa or more, for example. When the surface hardness is 10 GPa or less, the adhering strength between the thermally-detachable sheet and the adherend can be controlled.

The weight loss rate of the thermally-detachable sheet after the sheet is soaked in a 3% aqueous tetramethyl ammonium hydroxide solution for 5 min is preferably less than 1% by weight, more preferably less than 0.9% by weight, and further preferably less than 0.8% by weight. The smaller the weight loss rate is, the more preferable it is. However, it is 0% by weight or more or 0.001% by weight or more, for example. When the weight loss rate of the thermally-detachable sheet after the sheet is soaked in a 3% aqueous tetramethyl ammonium hydroxide solution for 5 min is less than 1% by weight, less elution of the thermally-detachable sheet into the 3% aqueous tetramethyl ammonium hydroxide solution occurs. Therefore, solvent resistance (especially, solvent resistance to an aqueous tetramethyl ammonium hydroxide solution) can be improved. The weight loss rate of the thermally-detachable sheet can be controlled by the composition of a diamine to be used (the solubility of a diamine in the aqueous tetramethyl ammonium hydroxide solution), for example.

The increased amount of particles of 0.2 μm or more on a surface of a silicon wafer when the thermally-detachable sheet is bonded to the silicon wafer and then peeled off is preferably less than 10,000 particles/6 inch wafer, more preferably less than 9,000 particles/6 inch wafer, and further preferably less than 8,000 particles/6 inch wafer with respect to the amount before the sheet is bonded to the silicon wafer. The increased amount of particles is especially preferably less than 1,000 particles/6 inch wafer, less than 900 particles/6 inch wafer, or less than 800 particles/6 inch wafer with respect to the amount before the sheet is bonded to the silicon wafer. When the increased amount of particles of 0.2 μm or more on the surface of a silicon wafer when the thermally-detachable sheet is bonded to the silicon wafer and then peeled off is less than 10,000 particles/6 inch wafer with respect to the amount before the sheet is bonded to the silicon wafer, adhesive residue after peeling can be suppressed.

The weight loss rate of the thermally-detachable sheet after the sheet is soaked in N-methyl-2-pyrrolidone (NMP) at 50° C. for 60 sec and dried at 150° C. for 30 min is preferably 1.0% by weight or more, more preferably 1.1% by weight or more, and further preferably 1.2% by weight more. The larger the weight loss rate is, the more preferable it is. However, it is 50% by weight or less or 40% by weight or less, for example. When the weight loss rate of the thermally-detachable sheet after the sheet is soaked in N-methyl-2-pyrrolidone (NMP) at 50° C. for 60 sec and dried at 150° C. for 30 min is 1.0% by weight or more, the thermally-detachable sheet is eluted into N-methyl-2-pyrrolidone, and the weight is sufficiently decreased. As a result, the thermally-detachable sheet can be easily peeled off by using N-methyl-2-pyrrolidone. The weight loss rate of the thermally-detachable sheet can be controlled by the solubility of the raw material of the thermally-detachable sheet in NMP, for example. That is, the higher the solubility of the selected raw material in NMP is, the higher the solubility of the thermally-detachable sheet obtained using the selected raw material in NMP becomes.

The forming material of the thermally-detachable sheet of the first aspect of the present invention is not especially limited as long as the shear adhering strength of the thermally-detachable sheet to a silicon wafer at 200° C. after the sheet is kept at that temperature for 1 min is 0.25 kg/5×5 mm or more and the shear adhering strength of the thermally-detachable sheet to a silicon wafer at any temperature in a temperature range of more than 200° C. and 500° C. or less after the sheet is kept at that temperature for 3 min is less than 0.25 kg/5×5 mm. However, examples include a polyimide resin, a silicone resin, an acrylic resin, a fluororesin, an epoxy resin, a urethane resin, and a rubber resin.

The polyimide resin can be generally obtained by performing imidization (dehydration condensation) of polyamic acid that is a precursor of the polyimide resin. A conventionally known method such as a heating imidization method, an azeotropic dehydration method, and a chemical imidization method can be adopted as the method of imidizing polyamic acid. Of these, a heating imidization method is preferable. When the heating imidization method is adopted, the heating treatment is preferably performed under an inert atmosphere such as under a nitrogen atmosphere or in vacuum to prevent deterioration caused by oxidation of the polyimide resin.

The polyamic acid can be obtained by charging an acid anhydride and a diamine (containing both a diamine having an ether structure and a diamine having no ether structure) in a substantially equimolar ratio in an appropriately selected solvent and reacting them.

The polyimide resin preferably has a constituent unit derived from a diamine having an ether structure. The diamine having an ether structure is not especially limited as long as it is a compound having an ether structure and at least two ends having an amine structure. Among diamines having an ether structure, a diamine having a glycol skeleton is preferable. When the polyimide resin has a constituent unit derived from a diamine having an ether structure, especially a constituent unit derived from a diamine having a glycol skeleton, the thermally-detachable sheet can be heated to a high temperature (for example, 200° C. or more) to decrease the shear adhering strength. The present inventors make an assumption on this phenomenon that the ether structure or the glycol skeleton is eliminated from the resin that constitutes the thermally-detachable sheet when the sheet is heated to a high temperature, and the shear adhering strength decreases due to this elimination.

Further, the elimination of the ether structure or the glycol skeleton from the resin that constitutes the thermally-detachable sheet can be confirmed, for example, by comparing the FT-IR (fourier transform infrared spectroscopy) spectra before and after the thermally-detachable sheet is heated at 300° C. for 30 min and confirming the decrease of the spectrum at 2,800 cm⁻¹ to 3,000 cm⁻¹ after the heating. Specifically, a decreased amount is obtained from the following formula (3) by comparing the spectrum peak intensity at 2,800 cm⁻¹ to 3,000 cm⁻¹ before heating with the spectrum peak at 2,800 cm⁻¹ cm⁻¹ cm⁻¹ to 3,000 cm⁻¹ after heating using the spectrum intensity of the benzene ring (the spectrum intensity at 1,500 cm⁻¹) as a standard. When the decreased amount is 1.0% or more, it can be determined that the ether structure or the glycol skeleton is eliminated from the resin that constitutes the thermally-detachable sheet.

[(Spectrum peak intensity at 2,800 cm⁻¹ to 3,000 cm⁻¹ after heating)/(Spectrum intensity at 1,500 cm⁻¹ after heating)]/[((Spectrum peak intensity at 2,800 cm⁻¹ to 3,000 cm⁻¹ before heating)/(Spectrum intensity at 1,500 cm⁻¹ before heating)]×100(%) Formula (3):

Examples of the diamine having a glycol skeleton include diamines having alkylene glycol such as a diamine having a polypropylene glycol structure and having an amino group on each end, a diamine having a polyethylene glycol structure and having an amino group on each end, and a diamine having a polytetramethylene glycol structure and having an amino group on each end. In addition, examples include diamines having a plurality of such glycol structures and having an amino group on each end.

The molecular weight of the diamine having an ether structure is preferably in a range of 100 to 5,000, and more preferably 150 to 4,800. When the molecular weight of a diamine having an ether structure is in a range of 100 to 5,000, a thermally-detachable sheet having high adhering strength at 200° C. or less and having a peeling property in a temperature range of 200° C. or more can be easily obtained.

In the formation of the polyimide resin, another diamine having no ether structure can be used together besides a diamine having an ether structure. Examples of another diamine having no ether structure include aliphatic diamines and aromatic diamines. Another diamine having no ether structure can be used together to control the adhesion with the adherend. The compounding ratio of a diamine having an ether structure to a diamine having no ether structure is preferably in a range of 100:0 to 10:90 by mole ratio, more preferably 100:0 to 20:80, and further preferably 99:1 to 30:70. When the compounding ratio of the diamine having an ether structure to the diamine having no ether structure is in a range of 100:0 to 10:90 by mole ratio, a superior thermal peeling property at a high temperature can be obtained.

Examples of the aliphatic diamines include ethylene diamine, hexamethylene diamine, 1,8-diaminooctane, 1,10-diaminodecane, 1,12-diaminododecane, 4,9-dioxa-1,12-diaminododecane, and 1,3-bis(3-aminopropyl)-1,1,3,3-tetramethyldisiloxane(α,ω-bisaminopropyltetramethyldisiloxane). The molecular weight of the aliphatic diamines is normally 50 to 1,000,000 and preferably 100 to 30,000.

Examples of the aromatic diamines include 4,4′-diaminodiphenylether, 3,4′-diaminodiphenylether, 3,3′-diaminodiphenylether, m-phenylene diamine, p-phenylene diamine, 4,4′-diaminodiphenylpropane, 3,3′-diaminodiphenylmethane, 4,4′-diaminodiphenylsulfide, 3,3′-diaminodiphenylsulfide, 4,4′-diaminodiphenylsulfone, 3,3′-diaminodiphenylsulfone, 1,4-bis(4-aminophenoxy)benzene, 1,3-bis(4-aminophenoxy)benzene, 1,3-bis(3-aminophenoxy)benzene, 1,3-bis(4-aminophenoxy)-2,2-dimethylpropane, and 4,4′-diaminobenzophenone. The molecular weight of the aromatic diamines is normally 50 to 1,000 and preferably 100 to 500. In the present description, the molecular weight is measured by GPC (gel permeation chromatography), and is a value (weight average molecular weight) calculated by polystyrene conversion.

Examples of the acid anhydride include 3,3′,4,4′-biphenyltetracarboxylic dianhydride, 2,2′,3,3′-biphenyltetracarboxylic dianhydride, 3,3′,4,4′-benzophenone tetracarboxylic dianhydride, 2,2′,3,3′-benzophenone tetracarboxylic dianhydride, 4,4′-oxydiphthalic dianhydride, 2,2-bis(2,3-dicarboxyphenyl) hexafluoropropane dianhydride, 2,2-bis(3,4-dicarboxyphenyl) hexafluoropropane dianhydride (6FDA), bis(2,3-dicarboxyphenyl)methane dianhydride, bis(3,4-dicarboxyphenyl)methane dianhydride, bis(2,3-dicarboxyphenyl) sulfone dianhydride, bis(3,4-dicarboxyphenyl) sulfone dianhydride, pyromellitic dianhydride, and ethylene glycol bistrimellitic dianhydride. These may be used either alone or in combination of two or more types.

Examples of the solvent that is used when reacting the acid anhydride with the diamine include N,N-dimethylacetamide, N-methyl-2-pyrrolidone, N,N-dimethylformamide, and cyclopentanone. These may be used either alone or in combination of a plurality of types. In addition, a nonpolar solvent such as toluene and xylene may be appropriately mixed to adjust the solubility of the raw material and resin.

(Manufacture of the Thermally-Detachable Sheet)

The thermally-detachable sheet according to the present embodiment can be produced as follows, for example. First, a solution containing the polyamic acid is produced. Additives may be appropriately contained in the polyamic acid. Then, the solution is applied onto a base to a prescribed thickness to form a coating film, and then the coating film is dried under a prescribed condition. Examples of the base that can be used include metal foils such as SUS304, 6-4 alloy, an aluminum foil, a copper foil, and a Ni foil; polyethylene terephthalate (PET); polyethylene; polypropylene; and plastic films, paper and the like whose surface is coated with a release agent such as a fluorine-based release agent or a long chain alkylacrylate-based release agent. The coating method is not especially limited. However, examples include roll coating, screen coating, gravure coating, and spin coating. The drying is performed in a drying condition of a drying temperature of 50° C. to 150° C. and a drying time of 3 min to 30 min, for example. In this manner, the thermally-detachable sheet according to the present embodiment can be obtained.

The thermally-detachable sheet can be used after being peeled off from the base. The thermally-detachable sheet may be transferred to a support and used as a thermally-detachable sheet with a support. In addition, the solution containing polyamic acid may be directly applied to a support to form a coating film, and then the coating film may be dried under a prescribed condition to produce the thermally-detachable sheet. When it is used as a thermally-detachable sheet with a support, the rigidity becomes higher than that when it is used as a thermally-detachable sheet alone. Therefore, it is preferable in respect of reinforcing the adherend.

The support is not especially limited. However, examples include compound wafers such as a silicon wafer, a SiC wafer, and a GaAs wafer; glass wafers; and metal foils such as SUS, 6-4 alloy, a Ni foil, and an Al foil. When the support having a round shape in planar view is adopted, a silicon wafer or a glass wafer is preferable. When the support has a rectangular shape in planar view, a SUS plate or a glass plate is preferable. The support of the thermally-detachable sheet with a support can be used for manufacturing various semiconductor devices as it is.

The support may be used either alone or in combination of two or more types. The thickness of the support is normally about 100 μm to 20 mm.

The use of the thermally-detachable sheet is not especially limited. However, it can be used in a manufacturing process of a semiconductor device, for example. More specifically, it can be used in a step of resin-sealing semiconductor chips all together and a step of forming an electrically conductive through-silicon via (TSV) that pierces a silicon chip, for example. In addition, it can be used in a use of preventing resin leakage by being bonded to the backside of a lead frame upon resin-sealing. Further, it can also be used in the processing of glass members (for example, lenses) and a manufacturing process of color filters, touch panels, and power modules.

Further, as a use of the thermally-detachable sheet, it can also be used in a manufacturing process of a semiconductor device having a structure in which a semiconductor chip is mounted on a wiring circuit board (for example, refer to JP-A-2010-141126). That is, it can be used as a thermally-detachable sheet in the following method of manufacturing a semiconductor device.

A method of manufacturing a semiconductor device having a structure in which a semiconductor chip is mounted on a wiring circuit board, including the steps of:

preparing a support having a thermally-detachable sheet,

forming a wiring circuit board on the thermally-detachable sheet of the support,

mounting a semiconductor chip to the wiring circuit board, and

peeling the support off together with the thermally-detachable sheet after the mounting with a surface of the thermally-detachable sheet opposite to the support as an interface.

Further, as a use of the thermally-detachable sheet, it can be used to fix a semiconductor wafer having a silicon through electrode (a through-silicon via) when the semiconductor wafer is produced. That is, it can be used as a thermally-detachable sheet in the following method of manufacturing a semiconductor device.

A method of manufacturing a semiconductor device, including the steps of:

fixing a semiconductor wafer to a pedestal using a thermally-detachable sheet,

performing a specific treatment to the semiconductor wafer that is fixed to the pedestal, and

separating the pedestal from the semiconductor wafer after the treatment.

The specific treatment preferably includes a step of grinding one surface of the semiconductor wafer in which a blind hole is not formed, of the surfaces of the semiconductor wafer in one of which the blind hole for forming a silicon through electrode is formed and the other of which the blind hole is not formed.

In addition, the specific treatment preferably also includes a step of grinding the semiconductor wafer in which the silicon through electrode is formed.

### Second Aspect of the Present Invention

In the following, points of the second aspect of the present invention that are different from those of the first aspect of the present invention are explained. The solvent-detachable sheet of the second aspect of the present invention exhibits the same characteristics as those of the thermally-detachable sheet of the first aspect of the present invention besides the characteristics that are specially explained in this section of the second aspect of the present invention.

The weight loss rate of the solvent-detachable sheet of the second aspect of the present invention after the sheet is soaked in N-methyl-2-pyrrolidone (NMP) at 50° C. for 60 sec and dried at 150° C. for 30 min is 1.0% by weight or more, preferably 1.2% by weight or more, and more preferably 1.3% by weight more. The larger the weight loss rate is, the more preferable it is. However, it is 50% by weight or less or 30% by weight or less, for example. Because the weight loss rate of the solvent-detachable sheet after the sheet is soaked in N-methyl-2-pyrrolidone (NMP) at 50° C. for 60 sec and dried at 150° C. for 30 min is 1.0% by weight or more, the solvent-detachable sheet is eluted into N-methyl-2-pyrrolidone, and the weight is sufficiently decreased. As a result, the solvent-detachable sheet can be easily peeled off by using N-methyl-2-pyrrolidone. The weight loss rate of the solvent-detachable sheet can be controlled by the solubility of the raw material of the solvent-detachable sheet in NMP. That is, the higher the solubility of the selected raw material in NMP is, the higher the solubility of the solvent-detachable sheet obtained using the selected raw material in NMP becomes.

The forming material of the solvent-detachable sheet of the second aspect of the present invention is not especially limited as long as the weight loss rate after the sheet is soaked in N-methyl-2-pyrrolidone (NMP) at 50° C. for 60 sec and dried at 150° C. for 30 min is 1.0% by weight or more. However, examples include a polyimide resin, a silicone resin, an acrylic resin, a fluororesin, an epoxy resin, a urethane resin, and a rubber resin.

### Third Aspect of the Present Invention

In the following, points of the third aspect of the present invention that are different from those of the first aspect of the present invention are explained. The thermally-detachable sheet of the third aspect of the present invention exhibits the same characteristics as those of the thermally-detachable sheet of the first aspect of the present invention besides the characteristics that are specially explained in this section of the third aspect of the present invention.

The thermally-detachable sheet according to the third aspect of the present invention has an imide group. The forming material of the thermally-detachable sheet is not especially limited as long as it has an imide group. However, examples include a polyimide resin. The polyimide resins that are explained in the section of the first aspect of the present invention can be used as the polyimide resin.

### Fourth Aspect of the Present Invention

In the following, points of the fourth aspect of the present invention that are different from those of the first aspect of the present invention are explained. The thermally-detachable sheet of the fourth aspect of the present invention exhibits the same characteristics as those of the thermally-detachable sheet of the first aspect of the present invention besides the characteristics that are specially explained in this section of the fourth aspect of the present invention.

The shear adhering strength of the thermally-detachable sheet of the fourth aspect of the present invention to a silicon wafer at any temperature in a temperature range of 200° C. or less after the sheet is kept at that temperature for 1 min is 0.25 kg/5×5 mm or more, preferably 0.30 kg/5×5 mm or more, and more preferably 0.50 kg/5×5 mm or more. Further, the shear adhering strength of the thermally-detachable sheet to a silicon wafer at any temperature in a temperature range of more than 200° C. and 500° C. or less after the sheet is kept at that temperature for 3 min is less than 0.25 kg/5×5 mm, preferably less than 0.10 kg/5×5 mm, and more preferably less than 0.05 kg/5×5 mm.

The above-described “any temperature in a temperature range of 200° C. or less” is not especially limited as long as it is 200° C. or less. However, it can be any temperature in a temperature range of −20° C. to 195° C., any temperature in a temperature range of 0° C. to 180° C., or any temperature in a temperature range of 20° C. to 150° C.

The above-described temperature at which the shear adhering strength of the thermally-detachable sheet to a silicon wafer becomes less than 0.25 kg/5×5 mm (preferably, less than 0.10 kg/5×5 mm, and more preferably less than 0.05 kg/5×5 mm) is not especially limited as long as it is any temperature in a temperature range of more than 200° C. and 500° C. or less. However, it is preferably more than 220° C. and 480° C. or less, and more preferably more than 240° C. and 450° C. or less.

Because the shear adhering strength of the thermally-detachable sheet to a silicon wafer at any temperature in a temperature range of 200° C. or less after the sheet is kept at that temperature for 1 min is 0.25 kg/5×5 mm or more and the shear adhering strength of the thermally-detachable sheet to a silicon wafer at any temperature in a temperature range of more than 200° C. and 500° C. or less after the sheet is kept at that temperature for 3 min is less than 0.25 kg/5×5 mm, when the thermally-detachable sheet is kept at any temperature in a temperature range of more than 200° C. and 500° C. or less for 3 min, the shear adhering strength decreases compared to when it is kept at any temperature in a temperature range of 200° C. or less for 1 min. In addition, because the thermally-detachable sheet does not substantially contain a foaming agent, it is excellent in respect of absence of contamination, especially absence of contamination with metals that are generated from a foaming agent. That is, problems of migration originated from metal contamination and corrosion are less likely to occur. That is, according to the fourth aspect of the present invention, a thermally-detachable sheet that exhibits a peeling property at a higher temperature in a state in which the thermally-detachable sheet does not substantially contain a foaming agent can be provided. The shear adhering strength of the thermally-detachable sheet can be controlled by the number of functional groups included in the thermally-detachable sheet, for example.

The shear adhering strength of the thermally-detachable sheet to a silicon wafer may become less than 0.25 kg/5×5 mm even at 200° C. or less when the sheet is kept for a long time (for example, 30 min or more). Further, the shear adhering strength of the thermally-detachable sheet to a silicon wafer may not become less than 0.25 kg/5×5 mm if the sheet is kept for a short time (for example, within 0.1 min) even when the sheet is kept at a temperature higher than 200° C. (for example, 210° C. to 400° C.).

That is, “the shear adhering strength to a silicon wafer at any temperature in a temperature range of more than 200° C. and 500° C. or less after the sheet is kept at that temperature for 3 min is less than 0.25 kg/5×5 mm” in the fourth aspect of the present invention is an indicator for evaluating the peeling property at a high temperature, and it does not mean that the shear adhering strength to a silicon wafer necessarily becomes less than 0.25 kg/5×5 mm when the temperature is “any temperature in a temperature range of more than 200° C. and 500° C. or less”. Also, it does not mean that the peeling property cannot be exhibited unless the temperature is “any temperature in a temperature range of more than 200° C. and 500° C. or less”.

The thermally-detachable sheet does not substantially contain a foaming agent. “Does not substantially contain a foaming agent” refers to a state where the content of a foaming agent is 0.1% by weight or less, and it is preferably 0.05% by weight or less and more preferably 0.03% by weight or less.

An example of the foaming agent is a conventionally known thermally expandable microsphere. An example of the thermally expandable microsphere is a microencapsulated thermally expandable microsphere. Examples of the thermally expandable microsphere include a microsphere in which a substance that easily gasifies and expands by heating, such as isobutane, propane, or pentane, is encapsulated in an elastic shell. The shell can be formed of a thermofusible substance or a substance that bursts by thermal expansion.

The forming material of the thermally-detachable sheet of the fourth aspect of the present invention is not especially limited as long as the thermally-detachable sheet does not substantially contain a foaming agent, the shear adhering strength of the thermally-detachable sheet to a silicon wafer at any temperature in a temperature range of 200° C. or less after the sheet is kept at that temperature for 1 min is 0.25 kg/5×5 mm or more and the shear adhering strength of the thermally-detachable sheet to a silicon wafer at any temperature in a temperature range of more than 200° C. and 500° C. or less after the sheet is kept at that temperature for 3 min is less than 0.25 kg/5×5 mm. However, examples include a polyimide resin, a silicone resin, an acrylic resin, a fluororesin, an epoxy resin, a urethane resin, and a rubber resin.

(Manufacture of the Thermally-Detachable Sheet)

The thermally-detachable sheet according to the present embodiment can be produced as follows, for example. First, a solution containing the polyamic acid (refer to the section of the first aspect of the present invention) is produced. Additives may be appropriately contained in the polyamic acid. However, a foaming agent is not substantially contained. Then, the solution is applied onto a base to a prescribed thickness to form a coating film, and then the coating film is dried under a prescribed condition. Examples of the base that can be used include metal foils such as SUS304, 6-4 alloy, an aluminum foil, a copper foil, and a Ni foil; polyethylene terephthalate (PET); polyethylene; polypropylene; and plastic films, paper and the like whose surface is coated with a release agent such as a fluorine-based release agent or a long chain alkylacrylate-based release agent. The coating method is not especially limited. However, examples include roll coating, screen coating, and gravure coating. The drying is performed in a drying condition of a drying temperature of 50° C. to 150° C. and a drying time of 3 min to 30 min, for example. In this manner, the thermally-detachable sheet according to the present embodiment can be obtained.

### Fifth Aspect of the Present Invention

In the following, points of the fifth aspect of the present invention that are different from those of the first aspect of the present invention are explained. The thermally-detachable sheet of the fifth aspect of the present invention exhibits the same characteristics as those of the thermally-detachable sheet of the first aspect of the present invention besides the characteristics that are specially explained in this section of the fifth aspect of the present invention.

The thermally-detachable sheet according to the fifth aspect of the present invention (a) has a thermal curing rate of 80% or more or (b) contains a polyimide resin and has an imidization rate of 80% or more.

In the case of (a), the thermal curing rate of the thermally-detachable sheet according to the fifth aspect of the present invention is 80% or more, preferably 90% or more, and more preferably 95% or more. The higher the upper limit of the thermal curing rate of the thermally-detachable sheet is, the more preferable it is, and it is 100% or 99.9%, for example. Because the thermal curing rate of the thermally-detachable sheet is 80% or more (for example, 80% to 100%), further thermal curing hardly occurs when the thermally-detachable sheet is used in a high temperature environment. As a result, the thermally-detachable sheet has excellent durability at high temperature. In the fifth aspect of the present invention, “thermally cured” refers to that the resin constituting the thermally-detachable sheet causes a chemical reaction due to heat and is cured forming a three-dimensional crosslinking bond between molecules, and it does not include deterioration due to oxidation or decomposition.

The thermal curing rate is obtained by measuring the amount of heat generation using DSC (differential scanning calorimetry). Specifically, the amount of heat generation (the total amount of heat generation) is measured when the temperature is increased to 500° C. (the temperature at which the thermal curing reaction is assumed to be thoroughly completed) from room temperature (23° C.) under the condition of a temperature rise rate of 10° C./min using a thermally-detachable sheet obtained by applying a solution (a solution containing polyamic acid) for manufacturing a thermally-detachable sheet and drying the solution (condition: at 120° C. for 10 min). Further, the amount of heat generation (the amount of heat generation after the thermally-detachable sheet is manufactured) is measured when the temperature is increased to 500° C. (the temperature at which the thermal curing reaction is assumed to be thoroughly completed) from room temperature (23° C.) under the condition of a temperature rise rate of 10° C./min using a thermally-detachable sheet obtained by applying a solution for manufacturing a thermally-detachable sheet and drying the solution, and then completing the manufacturing process by prescribed heating. After that, the thermal curing rate is calculated from the following formula (1).

[1−((Amount of heat generation after the thermally-detachable sheet is manufactured)/(Total amount of heat generation))]×100% Formula (1):

Further, the amount of heat generation of reaction in a temperature range of ±5° C. of a peak temperature of heat generation of reaction that is measured by a differential scanning calorimeter is used for the amount of heat generation.

The forming material of the thermally-detachable sheet is not especially limited as long as the thermal curing rate is 80% or more. However, examples include a polyimide resin, a silicone resin, an acrylic resin, a fluororesin, an epoxy resin, a urethane resin, and a rubber resin.

The thermally-detachable sheet according to (b) contains a polyimide resin, and the imidization rate is 80% or more. The thermally-detachable sheet has only to contain a polyimide resin. That is, the thermally-detachable sheet may contain other resins besides a polyimide resin or may consist only of a polyimide resin. When the thermally-detachable sheet contains a polyimide resin or when it consists only of a polyimide resin, the imidization rate is 80% or more, preferably 90% or more, and more preferably 95% or more. Of these, the imidization rate of the thermally-detachable sheet is further preferably 98% or more (especially, 99% or more). The higher the upper limit of the imidization rate of the thermally-detachable sheet is, the more preferable it is, and it is 100% or 99.9%, for example. When the imidization rate of the thermally-detachable sheet is 80% or more (for example, 80% to 100%), further imidization hardly occurs when the thermally-detachable sheet is used in a high temperature environment. As a result, the thermally-detachable sheet has excellent durability at high temperature.

The imidization rate is obtained by measuring the peak intensity of the imide group using 1H-NMR (proton nuclear magnetic resonance, LA400 manufactured by JEOL Ltd.). Specifically, a solution (a solution containing polyamic acid) for manufacturing the thermally-detachable sheet is applied and dried (drying condition: at 50° C. to 150° C. for 5 min to 30 min), and the imidization (imidization condition: at 200° C. to 450° C. for 1 hr to 5 hr) is performed. In this state, a peak area A originated from an O—R proton (a peak area originated from an O—R proton in a state in which a diamine of polyamic acid and an acid anhydride are not ring-closed) and a peak area B originated from an imide group N—R proton (a peak area originated from an N—R proton in a state in which a diamine of polyamic acid and an acid anhydride are ring-closed) are obtained, and the imidization rate (%) was obtained from the formula (2).

[(B)/(A+B)]×100(%) Formula (2):

The polyimide resin that is explained in the section of the first aspect of the present invention can be used as the polyimide resin for the thermally-detachable sheet according to (a) and the thermally-detachable sheet according to (b).

In the formation of the polyimide resin, another diamine having no ether structure can be used together besides a diamine having an ether structure. Examples of another diamine having no ether structure include aliphatic diamines and aromatic diamines. Another diamine having no ether structure is used together to control the adhesion with the adherend. The mixing ratio of a diamine having an ether structure to another diamine having no ether structure (the amount in parts by weight of a diamine having an ether structure: the amount in parts by weight of another diamine having no ether structure) is preferably 15:85 to 80:20, and more preferably 20:80 to 70:30. Here, the compounded amount in parts by weight of a diamine having an ether structure is the compounded amount in parts by weight of a diamine having an ether structure when the total compounding weight excluding a solvent is 100 parts by weight. Further, the compounded amount in parts by weight of another diamine having no ether structure is the compounded amount in parts by weight of another diamine having no ether structure when the total compounding weight excluding a solvent is 100 parts by weight.

The shear adhering strength of the thermally-detachable sheet of the fifth aspect of the present invention to a silicon wafer at any temperature in a temperature range of 200° C. or less after the sheet is kept at that temperature for 1 min is preferably 0.25 kg/5×5 mm or more, more preferably 0.30 kg/5×5 mm or more, and further preferably 0.50 kg/5×5 mm or more. Further, the shear adhering strength of the thermally-detachable sheet to a silicon wafer at any temperature in a temperature range of more than 200° C. and 500° C. or less after the sheet is kept at that temperature for 3 min is preferably less than 0.25 kg/5×5 mm, more preferably less than 0.10 kg/5×5 mm, and further preferably less than 0.05 kg/5×5 mm.

The above-described “any temperature in a temperature range of 200° C. or less” is not especially limited as long as it is 200° C. or less. However, it can be any temperature in a temperature range of −20° C. to 195° C., any temperature in a temperature range of 0° C. to 180° C., or any temperature in a temperature range of 20° C. to 150° C.

In addition, the temperature at which the shear adhering strength of the thermally-detachable sheet to a silicon wafer becomes less than 0.25 kg/5×5 mm (more preferably, less than 0.10 kg/5×5 mm, and further preferably less than 0.05 kg/5×5 mm) is not especially limited as long as it is any temperature in a temperature range of more than 200° C. and 500° C. or less. However, it is preferably more than 205° C. and 400° C. or less, and more preferably more than 210° C. and 300° C. or less.

When the shear adhering strength of the thermally-detachable sheet to a silicon wafer at any temperature in a temperature range of 200° C. or less after the sheet is kept at that temperature for 1 min is 0.25 kg/5×5 mm or more and the shear adhering strength of the thermally-detachable sheet to a silicon wafer at any temperature in a temperature range of more than 200° C. and 500° C. or less after the sheet is kept at that temperature for 3 min is less than 0.25 kg/5×5 mm, when the thermally-detachable sheet is kept at any temperature in a temperature range of more than 200° C. and 500° C. or less for 3 min, the shear adhering strength decreases compared to when it is kept at any temperature in a temperature range of 200° C. or less for 1 min. The shear adhering strength of the thermally-detachable sheet can be controlled by the number of functional groups included in the thermally-detachable sheet, for example.

### Sixth Aspect of the Present Invention

In the following, points of the sixth aspect of the present invention that are different from those of the first aspect of the present invention are explained. The thermally-detachable sheet of the sixth aspect of the present invention exhibits the same characteristics as those of the thermally-detachable sheet of the first aspect of the present invention besides the characteristics that are specially explained in this section of the sixth aspect of the present invention.

The shear adhering strength of the thermally-detachable sheet of the sixth aspect of the present invention to a silicon wafer at any temperature in a temperature range of 200° C. or less after the sheet is kept at that temperature for 1 min is 0.25 kg/5×5 mm or more, preferably 0.30 kg/5×5 mm or more, and more preferably 0.50 kg/5×5 mm or more. Further, the shear adhering strength of the thermally-detachable sheet to a silicon wafer at any temperature in a temperature range of more than 200° C. and 500° C. or less after the sheet is kept at that temperature for 3 min is less than 0.25 kg/5×5 mm, preferably less than 0.10 kg/5×5 mm, and more preferably less than 0.05 kg/5×5 mm.

The above-described “any temperature in a temperature range of 200° C. or less” is not especially limited as long as it is 200° C. or less. The above-described “any temperature in a temperature range of 200° C. or less” can be made to be a desired temperature by controlling the ratio of the constituent unit derived from a diamine having an ether structure to the constituent unit derived from another diamine having no ether structure.

The above-described “any temperature in a temperature range of 200° C. or less” is not especially limited as long as it is 200° C. or less. However, it can be any temperature in a temperature range of −20° C. to 195° C., any temperature in a temperature range of 0° C. to 180° C., or any temperature in a temperature range of 20° C. to 150° C.

The above-described temperature at which the shear adhering strength of the thermally-detachable sheet to a silicon wafer becomes less than 0.25 kg/5×5 mm (preferably, less than 0.10 kg/5×5 mm, and more preferably less than 0.05 kg/5×5 mm) is not especially limited as long as it is any temperature in a temperature range of more than 200° C. and 500° C. or less. However, it is preferably more than 220° C. and 480° C. or less, and more preferably more than 240° C. and 450° C. or less.

Because the shear adhering strength of the thermally-detachable sheet to a silicon wafer at any temperature in a temperature range of 200° C. or less after the sheet is kept at that temperature for 1 min is 0.25 kg/5×5 mm or more and the shear adhering strength of the thermally-detachable sheet to a silicon wafer at any temperature in a temperature range of more than 200° C. and 500° C. or less after the sheet is kept at that temperature for 3 min is less than 0.25 kg/5×5 mm, when the thermally-detachable sheet is kept at any temperature in a temperature range of more than 200° C. and 500° C. or less for 3 min, the shear adhering strength decreases compared to when it is kept at any temperature in a temperature range of 200° C. or less for 1 min.

In addition, the ratio of the constituent unit derived from a diamine having an ether structure to the constituent unit derived from another diamine having no ether structure of the thermally-detachable sheet of the sixth aspect of the present invention is 10:90 to 70:30, preferably 12:88 to 58:32, and more preferably 15:85 to 55:45 by mole ratio. Because the ratio is 10:90 to 70:30, the shear adhering strength to a silicon wafer can be suitably controlled.

As described above, according to the sixth aspect of the present invention, a thermally-detachable sheet that exhibits a peeling property at a higher temperature and whose peeling temperature can be controlled can be provided.

The shear adhering strength of the thermally-detachable sheet to a silicon wafer may become less than 0.25 kg/5×5 mm even at 200° C. or less when the sheet is kept for a long time (for example, 30 min or more). Further, the shear adhering strength of the thermally-detachable sheet to a silicon wafer may not become less than 0.25 kg/5×5 mm if the sheet is kept for a short time (for example, within 0.1 min) even when the sheet is kept at a temperature higher than 200° C. (for example, 210° C. to 400° C.).

That is, “the shear adhering strength to a silicon wafer at any temperature in a temperature range of more than 200° C. and 500° C. or less after the sheet is kept at that temperature for 3 min is less than 0.25 kg/5×5 mm” in the sixth aspect of the present invention is an indicator for evaluating the peeling property at a high temperature, and it does not mean that the shear adhering strength to a silicon wafer necessarily becomes less than 0.25 kg/5×5 mm when the temperature is “any temperature in a temperature range of more than 200° C. and 500° C. or less”. Also, it does not mean that the peeling property cannot be exhibited unless the temperature is “any temperature in a temperature range of more than 200° C. and 500° C. or less”.

The thermally-detachable sheet of the sixth aspect of the present invention is constituted from a polyimide resin.

The polyimide resins that are explained in the section of the first aspect of the present invention can be used as the polyimide resin. The polyimide resin preferably has a constituent unit derived from another diamine having no ether structure. Examples of another diamine having no ether structure include aliphatic diamines and aromatic diamines. As described above, the ratio of the constituent unit derived from a diamine having an ether structure to the constituent unit derived from another diamine having no ether structure of the thermally-detachable sheet is 10:90 to 70:30, preferably 12:88 to 58:32, and more preferably 15:85 to 55:45 by mole ratio. Because the ratio is 10:90 to 70:30, the shear adhering strength to a silicon wafer can be suitably controlled.

### Seventh Aspect of the Present Invention

In the following, points of the seventh aspect of the present invention that are different from those of the first aspect of the present invention are explained. The thermally-detachable sheet of the seventh aspect of the present invention exhibits the same characteristics as those of the thermally-detachable sheet of the first aspect of the present invention besides the characteristics that are specially explained in this section of the seventh aspect of the present invention.

According to the thermally-detachable sheet according to the seventh aspect of the present invention, the shear adhering strength of the thermally-detachable sheet to a silicon wafer after the sheet is kept at any temperature in a temperature range of more than 200° C. and 400° C. or less for 0.1 min to 60 min under a condition in which the oxygen concentration is 100 ppm or less is 0.25 kg/5×5 mm or more, preferably 0.30 kg/5×5 mm or more, and more preferably 0.50 kg/5×5 mm or more. The above-described “any temperature in a temperature range of more than 200° C. and 400° C. or less” is not especially limited as long as it is more than 200° C. and 400° C. or less. However, it can be any temperature in a temperature range of 200° C. to 350° C., any temperature in a temperature range of 200° C. to 300° C., or any temperature in a temperature range of 200° C. to 260° C.

The above-described “under a condition in which the oxygen concentration is 100 ppm or less” has only to be a condition in which the oxygen concentration is 100 ppm or less, and an oxygen concentration of 50 ppm will do, for example. As long as a condition in which the oxygen concentration is 100 ppm or less is employed, the total pressure may be smaller than the atmospheric pressure (a reduced pressure state) or may be about the atmospheric pressure. An example of the method of setting the pressure at about the atmospheric pressure is a method of employing an atmosphere of an inert gas (a rare-gas element such as helium, neon, or argon, or nitrogen), for example. Further, the present inventors assume that a high shear adhering strength can be maintained in a condition in which the oxygen concentration is low even when the sheet is heated to a high temperature because the thermally-detachable sheet is less likely to be oxidized and deteriorated in a condition in which the oxygen concentration is low.

Further, the shear adhering strength of the thermally-detachable sheet to a silicon wafer at any temperature in a temperature range of more than 50° C. and 300° C. or less after the sheet is kept at that temperature for 0.1 min to 60 min under an atmospheric pressure condition in which the oxygen concentration is 18 vol % to 25 vol % (% by volume) is less than 0.25 kg/5×5 mm, preferably less than 0.10 kg/5×5 mm, and more preferably less than 0.05 kg/5×5 mm. Under an atmospheric pressure condition in which the oxygen concentration is 18 vol % to 25 vol % (% by volume), the temperature at which the shear adhering strength of the thermally-detachable sheet to a silicon wafer becomes less than 0.25 kg/5×5 mm (preferably, less than 0.10 kg/5×5 mm, and more preferably less than 0.05 kg/5×5 mm) is not especially limited as long as it is any temperature in a temperature range of more than 50° C. and 300° C. or less. However, it is preferably more than 60° C. and 280° C. or less, and more preferably more than 70° C. and 270° C. or less. Further, the atmospheric pressure in the present description refers to 101,325 Pa.

Because the shear adhering strength of the thermally-detachable sheet to a silicon wafer after the sheet is kept at any temperature in a temperature range of more than 200° C. and 400° C. or less for 0.1 min to 60 min under a condition in which the oxygen concentration is 100 ppm or less is 0.25 kg/5×5 mm or more, the thermally-detachable sheet is not peeled off even when being exposed to a relatively high temperature. On the other hand, because the shear adhering strength of the thermally-detachable sheet to a silicon wafer after the sheet is kept at any temperature in a temperature range of 50° C. or more and 300° C. or less for 1 min to 30 min under an atmospheric pressure condition in which the oxygen concentration is 18 vol % to 25 vol % is less than 0.25 kg/5×5 mm, the thermally-detachable sheet is peeled off at a lower temperature in a condition in which the oxygen concentration is at the same level as that of the atmosphere compared to the condition in which the oxygen concentration is low. As described above, according to the seventh aspect of the present invention, a thermally-detachable sheet can be provided that is not peeled off even when being exposed to a relatively high temperature under the condition of a low oxygen concentration, and that exhibits a peeling property at a relatively low temperature in a condition in which the oxygen concentration is at the same level as that of the atmosphere compared to the temperature in the condition of a low oxygen concentration.

Such a thermally-detachable sheet is especially useful when it is desirable that the thermally-detachable sheet is not peeled off under the condition of low oxygen concentration and high temperature. For example, the thermally-detachable sheet is useful when two sheets are adhered to each other with the thermally-detachable sheet in between and a deposited film is to be formed (for example, sputtering or the like) on the sheet while keeping the two sheets without peeling away from each other.

The forming material of the thermally-detachable sheet of the seventh aspect of the present invention is not especially limited as long as the shear adhering strength of the thermally-detachable sheet to a silicon wafer at any temperature in a temperature range of more than 200° C. and 400° C. or less after the sheet is kept at that temperature for 0.1 min to 60 min under a condition in which the oxygen concentration is 100 ppm or less is 0.25 kg/5×5 mm or more and the shear adhering strength of the thermally-detachable sheet to a silicon wafer at any temperature in a temperature range of 50° C. or more and 300° C. or less after the sheet is kept at that temperature for 1 min to 30 min under an atmospheric pressure condition in which the oxygen concentration is 18 vol % to 25 vol % is less than 0.25 kg/5×5 mm. However, examples include a polyimide resin, a silicone resin, an acrylic resin, a fluororesin, an epoxy resin, a urethane resin, and a rubber resin. The polyimide resins that are explained in the section of the first aspect of the present invention can be used as the polyimide resin.

In the formation of the polyimide resin, another diamine having no ether structure can be used together besides a diamine having an ether structure. Examples of another diamine having no ether structure include aliphatic diamines and aromatic diamines. Another diamine having no ether structure is used together to control the adhesion with the adherend. The ratio of a diamine having an ether structure is preferably 15 parts by weight to 80 parts by weight and more preferably 20 parts by weight to 70 parts by weight. Here, the compounded amount in parts of a diamine having an ether structure is the compounded amount in parts by weight of a diamine having an ether structure when the total compounded weight excluding a solvent is 100 parts by weight. Specific examples of another diamine having no ether structure are as explained in the section of the first aspect of the present invention.

### Eighth Aspect of the Present Invention

In the following, points of the eighth aspect of the present invention that are different from those of the first aspect of the present invention are explained. The release layer of the eighth aspect of the present invention exhibits the same characteristics as those of the thermally-detachable sheet of the first aspect of the present invention besides the characteristics that are specially explained in this section of the eighth aspect of the present invention.

In the following, one example of the embodiment of the eighth aspect of the present invention is explained with reference to the drawings. FIGS. 1 to 3 are schematic cross-sectional diagrams for illustrating an outline of the method of manufacturing a semiconductor device according to one embodiment of the eighth aspect of the present invention. In the following, the outline of the method of manufacturing a semiconductor device according to the present embodiment is explained. Further, the “upper surface,” the “lower surface,” and the like that are used in the eighth aspect of the present invention are intended merely to explain the positional relationship of the layers, and they do not limit the actual upper and lower position of the wiring circuit board and the semiconductor device.

The method of manufacturing a semiconductor device according to the present embodiment is a method of manufacturing a semiconductor device having a structure in which a semiconductor chip is mounted on a wiring circuit board, including at least the steps of: preparing a support having a release layer, forming a wiring circuit board on the release layer of the support, mounting a semiconductor chip to the wiring circuit board, and peeling the support off together with the release layer after the mounting with a surface of the release layer opposite to the support as an interface, in which the shear adhering strength of the release layer to a silicon wafer at 200° C. after the sheet is kept at that temperature for 1 min is 0.25 kg/5×5 mm or more, and the shear adhering strength of the release layer to a silicon wafer at any temperature in a temperature range of more than 200° C. and 500° C. or less after the sheet is kept at that temperature for 3 min is less than 0.25 kg/5×5 mm.

In the manufacturing method, first, a support 1 having a release layer 5 is prepared (refer to FIG. 1). Then, a wiring circuit board 2 having a conductor portion 21 for connection that can be connected to electrodes 31 of a semiconductor chip 3 is formed on the release layer 5 so that the conductor portion 21 for connection is exposed to the upper surface of the wiring circuit board 2. The wiring circuit board 2 has on the release layer 5 side a conductor portion 22 for external connection for performing electrical connection with the outside. Further, FIG. 1 shows a case in which the conductor portion 21 for connection is convexly exposed to the upper surface of the wiring circuit board 2. However, the conductor portion for connection in the eighth aspect of the present invention has only to be exposed to the upper surface of the wiring circuit board, and the upper surface of the conductor portion for connection may be the same surface as the upper surface of the wiring circuit board.

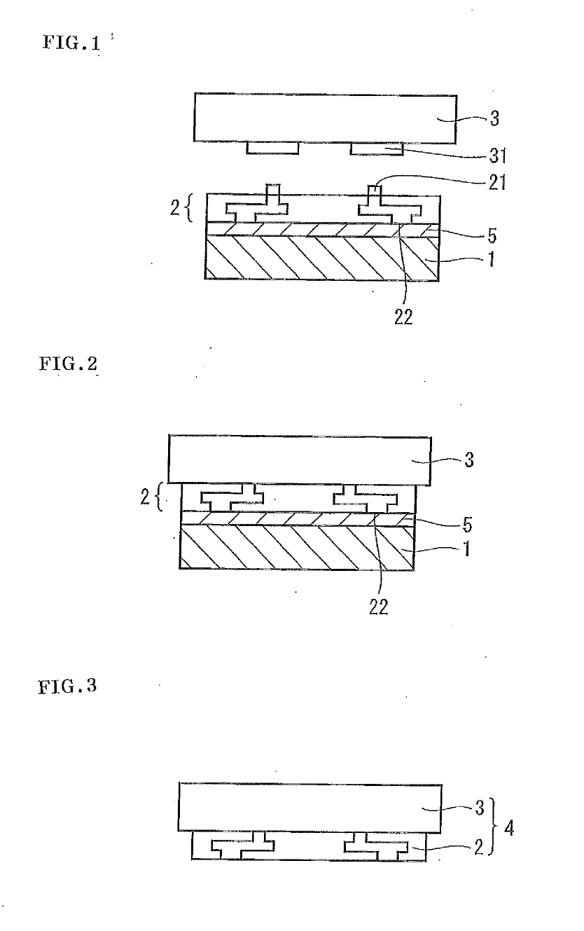

Next, as shown in FIG. 2, the conductor portion 21 for connection of the wiring circuit board 2 and the electrodes 31 of the semiconductor chip 3 are connected to each other to mount the semiconductor chip 3 to the wiring circuit board 2. Further, a projection of each of the conductor portion 21 for connection after mounting and the electrode 31 is omitted in FIG. 2.

Next, as shown in FIG. 3, the support 1 is peeled off together with the release layer 5 with a surface of the release layer 5 opposite to the support 1 as an interface. With this operation, a semiconductor device 4 in which the semiconductor chip 3 is mounted on the wiring circuit board 2 is obtained. Further, processing of providing a soldering ball to the wiring circuit board 2 from which the support 1 has been peeled off may be performed.

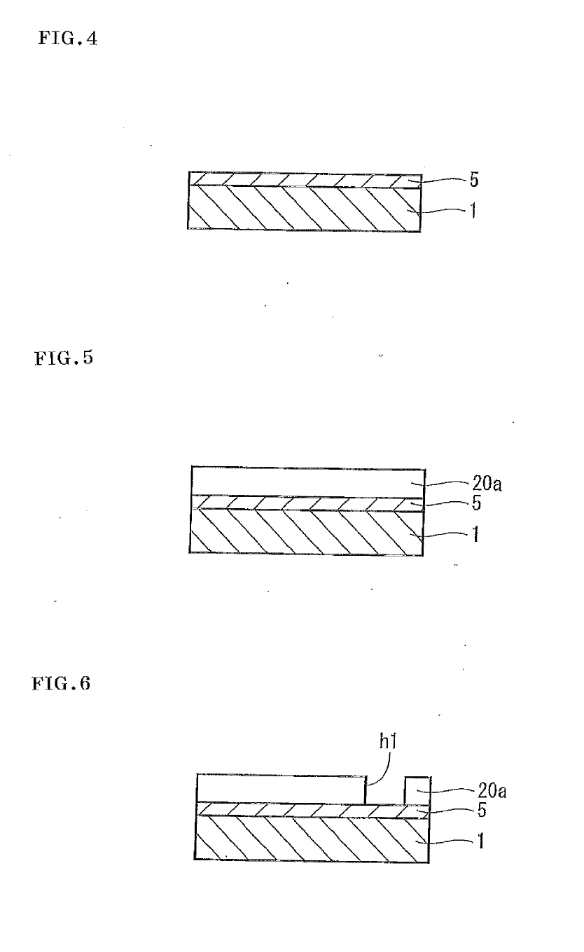

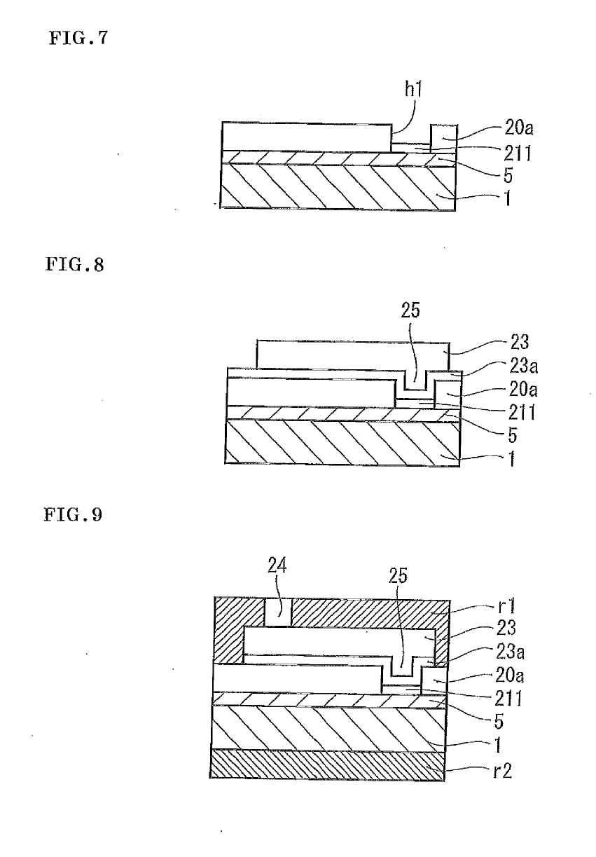

The outline of the method of manufacturing a semiconductor device according to the present embodiment has been explained above. In the following, one example of the method of manufacturing a semiconductor device according to the present embodiment is explained in detail with reference to FIGS. 4 to 11. FIGS. 4 to 11 are schematic cross-sectional diagrams for illustrating in detail one example of the method of manufacturing a semiconductor device shown in FIG. 3.

[Preparation of the Support Having a Release Layer]

First, the support 1 is prepared (refer to FIG. 4). The support 1 preferably has a strength of a certain level or more.

The support 1 is not especially limited. However, examples include compound wafers such as a silicon wafer, a SiC wafer, and a GaAs wafer; glass wafers; and metal foils such as SUS, 6-4 alloy, a Ni foil, and an Al foil. When a round shape in planar view is adopted, a silicon wafer or a glass wafer is preferable. When the support has a rectangular shape in planar view, a SUS plate or a glass plate is preferable.

Further, examples of the support 1 include polyolefins such as low density polyethylene, linear polyethylene, medium density polyethylene, high density polyethylene, ultralow density polyethylene, random copolymerized polypropylene, block copolymerized polypropylene, homopolypropylene, polybutene, and polymethylpentene; an ethylene-vinyl acetate copolymer; an aionomer resin; an ethylene-(meth)acrylic acid copolymer; an ethylene-(meth)acrylate (random, alternate) copolymer; an ethylene-butene copolymer; an ethylene-hexene copolymer; polyurethane; polyesters such as polyethylene terephthalate and polyethylene naphthalate; polycarbonates; polyimides; polyetheretherketone; polyimides; polyetherimides; polyamides; wholly aromatic polyamides; polyphenylsulfide; aramid (paper); glass; glass cloth; a fluororesin; polyvinyl chloride; polyvinylidene chloride; a cellulose-based resin; a silicone resin; and paper.

The support 1 may be used either alone or in combination of two or more types. The thickness of the support is not especially limited, but is normally about 10 μm to 20 mm.

Next, the release layer 5 is formed on the support 1.

The shear adhering strength of the release layer 5 to a silicon wafer at 200° C. after the sheet is kept at that temperature for 1 min is 0.25 kg/5×5 mm or more, preferably 0.30 kg/5×5 mm or more, and more preferably 0.50 kg/5×5 mm or more. Further, the shear adhering strength of the release layer 5 to a silicon wafer at any temperature in a temperature range of more than 200° C. and 500° C. or less after the sheet is kept at that temperature for 3 min is less than 0.25 kg/5×5 mm, preferably less than 0.10 kg/5×5 mm, and more preferably less than 0.05 kg/5×5 mm. Because the shear adhering strength of the release layer 5 to a silicon wafer at 200° C. after the sheet is kept at that temperature for 1 min is 0.25 kg/5×5 mm or more and the shear adhering strength of the release layer 5 to a silicon wafer at any temperature in a temperature range of more than 200° C. and 500° C. or less after the sheet is kept at that temperature for 3 min is less than 0.25 kg/5×5 mm, the release layer 5 is not peeled off even when being exposed to a comparatively high temperature, and it is peeled off at a temperature in a still higher temperature range. As a result, the support 1 and the wiring circuit board 2 are made not to be peeled away from each other when the wiring circuit board 2 is formed on the support 1, and they can be peeled away from each other after the semiconductor chip 3 is mounted on the wiring circuit board 2. The shear adhering strength of the release layer 5 can be controlled by the number of functional groups included in the release layer 5, for example.

In addition, the temperature at which the shear adhering strength of the release layer 5 to a silicon wafer becomes less than 0.25 kg/5×5 mm (preferably, less than 0.10 kg/5×5 mm, and more preferably less than 0.05 kg/5×5 mm) is not especially limited as long as it is any temperature in a temperature range of more than 200° C. and 500° C. or less. However, it is preferably more than 220° C. and 480° C. or less, and more preferably more than 240° C. and 450° C. or less.

The shear adhering strength of the release layer to a silicon wafer may become less than 0.25 kg/5×5 mm even at 200° C. or less when the sheet is kept for a long time. Further, the shear adhering strength of the release layer to a silicon wafer may not become less than 0.25 kg/5×5 mm if the sheet is kept for a short time even when the sheet is kept at a temperature higher than 200° C.

That is, “the shear adhering strength to a silicon wafer at any temperature in a temperature range of more than 200° C. and 500° C. or less after the sheet is kept at that temperature for 3 min is less than 0.25 kg/5×5 mm” is an indicator for evaluating the peeling property at a high temperature, and it does not mean that the shear adhering strength to a silicon wafer necessarily becomes less than 0.25 kg/5×5 mm when the temperature is “any temperature in a temperature range of more than 200° C. and 500° C. or less”. Also, it does not mean that the peeling property cannot be exhibited unless the temperature is “any temperature in a temperature range of more than 200° C. and 500° C. or less”.

The thermally-detachable sheet according to the first aspect of the present invention can be used as the release layer 5.

The release layer 5 may be transferred to the support 1 to produce the support 1 having the release layer 5. In addition, the solution containing polyamic acid may be directly applied to the support 1 to form a coating film, and then the coating film may be dried under a prescribed condition to produce the support 1 having the release layer 5.

[Formation of the Wiring Circuit Board]

Next, the wiring circuit board 2 is formed on the release layer 5 of the support 1. A conventionally known technique of manufacturing a circuit board and an interposer such as a semiadditive process or a subtractive process may be applied for the method of forming the wiring circuit board on the support having the release layer. By forming the wiring circuit board on the support, the dimensional stability is improved during the manufacturing process, and the handling property of a thin wiring circuit board is improved. In the following, one example of the method of forming the wiring circuit board is shown.

[Formation of a Base Insulating Layer]

As shown in FIG. 5, a base insulating layer 20a is formed on the release layer 5 of the support 1. The materials of the base insulating layer 20a are not especially limited. However, examples include known synthetic resins such as a polyimide resin, an acrylic resin, a polyethernitrile resin, a polyethersulfone resin, an epoxy resin, a polyethylene terephthalate resin, a polyethylene naphthalate resin, and a polyvinyl chloride resin; and resins in which these resins are compounded with a synthetic fiber fabric, a glass fabric, a glass nonwoven fabric, or fine particles of TiO₂, SiO₂, ZrO₂, minerals, clay, or the like. Especially, from the viewpoint of forming, as the base insulating layer 20a, a flexible insulating layer having a smaller thickness, a larger mechanical strength, and more preferable electric characteristics (such as an insulation characteristic) after the support 1 is peeled off, a polyimide resin, an epoxy resin, and a glass fabric-compounded epoxy resin are preferable materials. Among these, materials having photosensitivity are preferable. The thickness of the base insulating layer 20a is preferably 3 μm to 50 μm.

Next, an opening h1 is formed at a position where the conductor portion 22 for external connection is to be formed (refer to FIG. 6). A conventionally known method can be adopted as the method of forming the opening h1. For example, when the base insulating layer 20a is formed using a resin having photosensitivity, light is radiated through a photomask in which a pattern corresponding to the opening h1 is formed, and then it is developed to form the opening h1. The shape of the opening is not especially limited. However, a circular shape is preferable. The diameter can be appropriately set, and it is 5 μm to 500 μm, for example.

[Formation of a Metal Film for a Point of Contact]

Next, a metal film 211 for a point of contact is formed on the opening h1. By forming the metal film 211, it is possible to more preferably perform the electric connection and improve the corrosion resistance. The method of forming the metal film 211 is not especially limited. However, plating is preferable, and examples of the material of the metal film include single metals such as copper, gold, silver, platinum, lead, tin, nickel, cobalt, indium, rhodium, chromium, tungsten, and ruthenium; and alloys consisting of two types or more of these. Among these, examples of the preferred materials include gold, tin, and nickel, and an example of the preferred mode of the metal film is a two-layer structure having Ni as the base layer and Au as the surface layer.

[Formation of a Seed Film, a Lower Conductive Path, and a Conductor Layer]

Next, a seed film (a metal thin film) 23a is formed as necessary for preferably depositing a metal material on the wall surface that is to serve as a conductor layer 23 and a conductive path 25. The seed film 23a can be formed by sputtering, for example. Examples of the materials of the seed film include single metals such as copper, gold, silver, platinum, lead, tin, nickel, cobalt, indium, rhodium, chromium, tungsten, and ruthenium; and alloys consisting of two types or more of these. The thickness of the conductor layer 23 is not especially limited. However, it may be appropriately selected from a range of 1 nm to 500 nm. Further, the preferred shape of the conductive path 25 is a cylinder. The diameter is 5 μm to 500 and preferably 5 μm to 300 μm. After that, the conductor layer 23 having a prescribed wiring pattern and the conductive path 25 are formed. The wiring pattern can be formed by electrolytic plating, for example. After that, a portion of the seed film where no conductive layer 23 exists is removed.

Then, as shown in FIG. 9, the top of the conductor layer 23 is covered with a plating resist r1 (excluding the portion where the conductive path is to be formed), the lower surface of the support 1 is covered entirely with a resist r2, and electrolytic plating is performed to form a conductive path 24.

[Formation of an Adhesive Layer]

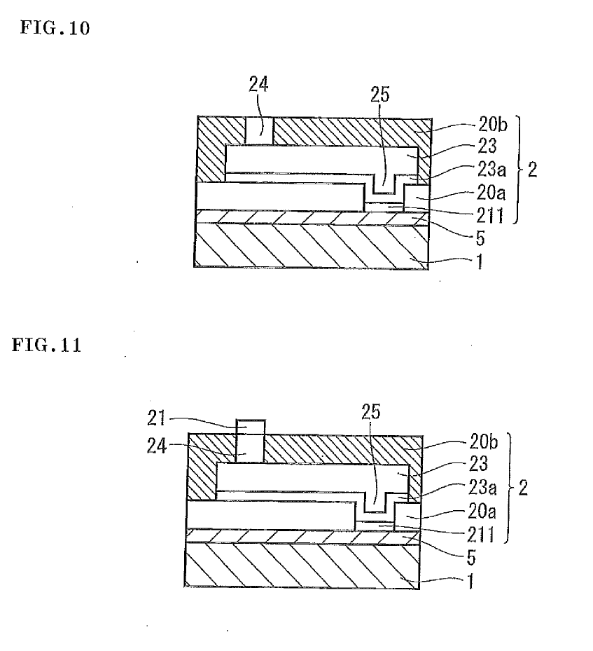

Next, the plating resists r1 and r2 are removed, an adhesive layer 20b having epoxy and polyimide as the main components is formed so that the exposed conductor layer 23 and the conductive path 24 are buried, and the adhesive layer is etched with an alkali solution or the like so that the top end surface of the conductive path 24 is exposed to the upper surface of the adhesive layer as a terminal part (refer to FIG. 10).

[Formation of a Metal Film on the End Surface of the Conductor Portion for Connection]

Next, as shown in FIG. 11, the conductor portion 21 for connection is formed on the top end surface of the conductive path 24 by electrolytic plating, for example. The conductor portion 21 for connection can be formed from a nickel film or a gold film, for example.

[Mounting Step, Peeling Step, and Dicing]

Next, a chip is mounted on the wiring circuit board 2 (to which the support 1 is bonded so that it can be peeled off) that is obtained above. After that, aging of the adhesive layer 20b is performed, and resin sealing is performed on each of the chips 3 on the wiring circuit board 2. Further, a sheet-shaped resin sheet for sealing may be used or a liquid resin sealing material may be used in resin sealing. Next, the support 1 is peeled off together with the release layer 5 with a surface of the release layer 5 opposite to the support 1 as an interface. With this operation, a semiconductor device 4 in which the semiconductor chip 3 is mounted on the wiring circuit board 2 is obtained. Further, a resin for underfilling may be used between the wiring circuit board 2 and the chip when the chip is mounted to the wiring circuit board 2 (flip-chip interconnection). The resin for underfilling may have a form of sheet or may be liquid. In the above-described embodiment, a case where the resin sealing is performed after the chip is mounted is explained. However, a chip in which a conventionally known film for the backside of a flip-chip semiconductor is formed may be used instead of performing resin sealing. The film for the backside of a flip-chip semiconductor is a film that is formed on the backside of a chip (a semiconductor element) that is flip-chip connected to an adherend. Explanation of the film is omitted here because the details are disclosed in JP-A-2011-249739, for example.

The lower limit of the temperature in the peeling step may be 50° C., 80° C., 100° C., 150° C., or 180° C., for example. Further, the upper limit of the temperature in the peeling step is preferably 260° C., more preferably 230° C., and further preferably 200° C. In addition, the time for keeping the wiring circuit board under the above-described temperature condition in the peeling step differs according to the temperature. However, it is preferably 0.05 min to 120 min, and more preferably 0.1 min or 30 min.

Further, the wiring circuit board is preferably not exposed to heat of 260° C. or more in the steps after the mounting step. With this operation, melting of solder and the like can be suppressed.

The method of manufacturing a semiconductor device of the eighth aspect of the present invention includes a method of obtaining a plurality of semiconductor devices by forming a wiring circuit board on a support (for example, a long support) having a release layer, mounting a plurality of semiconductor chips on the wiring circuit board, performing resin sealing, and then cutting the resultant. According to the method of manufacturing a semiconductor device, a wiring circuit board for a plurality of semiconductor devices can be formed on the support 1.

One example of the method of manufacturing a semiconductor device according to the present embodiment is explained above. However, the method of manufacturing a semiconductor device of the eighth aspect of the present invention is not limited to the above-described example, and it can be appropriately modified in the range of gist of the eighth aspect of the present invention.

### Ninth Aspect of the Present Invention

In the following, points of the ninth aspect of the present invention that are different from those of the eighth aspect of the present invention are explained. The release layer of the ninth aspect of the present invention exhibits the same characteristics as those of the release layer of the eighth aspect of the present invention besides the characteristics that are specially explained in this section of the ninth aspect of the present invention. The method of manufacturing a semiconductor device of the ninth aspect of the present invention can adopt the same steps as those of the method of manufacturing a semiconductor device of the eighth aspect of the present invention besides the steps that are specially explained in the section of the ninth aspect of the present invention.

In the following, only the parts of one example of the embodiment of the ninth aspect of the present invention that differ from the embodiment according to the eighth aspect of the present invention will be explained.

The method of manufacturing a semiconductor device according to the present embodiment is a method of manufacturing a semiconductor device having a structure in which a semiconductor chip is mounted on a wiring circuit board, including at least the steps of: preparing a support having a release layer, forming a wiring circuit board on the release layer of the support, mounting a semiconductor chip to the wiring circuit board, and peeling the support off together with the release layer after the mounting with a surface of the release layer opposite to the support as an interface, in which the weight loss rate of the release layer after the sheet is soaked in N-methyl-2-pyrrolidone at 50° C. for 60 sec and dried at 150° C. for 30 min is 1.0% by weight or more.

The release layer 5 of the embodiment according to the eighth aspect of the present invention can be used as the release layer 5 except for the characteristics explained below.

The weight loss rate of the release layer 5 after the sheet is soaked in N-methyl-2-pyrrolidone (NMP) at 50° C. for 60 sec and dried at 150° C. for 30 min is 1.0% by weight or more, preferably 1.2% by weight or more, and more preferably 1.3% by weight or more. In addition, the larger the weight loss rate is, the more preferable it is. However, it is 50% by weight or less or 30% by weight or less, for example. Since the weight loss rate of the release layer 5 after the sheet is soaked in N-methyl-2-pyrrolidone (NMP) at 50° C. for 60 sec and dried at 150° C. for 30 min is 1.0% by weight or more, the release layer 5 is eluted into N-methyl-2-pyrrolidone, and the weight is sufficiently decreased. As a result, the release layer 5 can be easily peeled off by using N-methyl-2-pyrrolidone. The weight loss rate of the release layer 5 can be controlled by the solubility of the raw material of the release layer in NMP. That is, the higher the solubility of the selected raw material in NMP is, the higher the solubility of the solvent-detachable sheet obtained using the selected raw material in NMP becomes.

The dynamic hardness of the release layer 5 is preferably 10 or less, more preferably 9 or less, and further preferably 8 or less. Further, the smaller the dynamic hardness is, the more preferable it is. However, it is 0.001 or more, for example. When the dynamic hardness is 10 or less, the adhering strength of the release layer 5 to an adherend can be made sufficient.

The surface hardness of the release layer 5 is preferably 10 GPa or less, more preferably 8 GPa or less, and further preferably 6 GPa or less. Further, the smaller the surface hardness is, the more preferable it is. However, it is 0.05 GPa or more, for example. When the surface hardness is 10 GPa or less, the adhering strength between the release layer 5 and the adherend can be controlled.

The weight loss rate of the release layer 5 after the sheet is soaked in a 3% aqueous tetramethyl ammonium hydroxide solution for 5 min is preferably less than 1% by weight, more preferably less than 0.9% by weight, and further preferably less than 0.8% by weight. The smaller the weight loss rate is, the more preferable it is. However, it is 0% by weight or more or 0.001% by weight or more, for example. When the weight loss rate of the release layer 5 after the sheet is soaked in a 3% aqueous tetramethyl ammonium hydroxide solution for 5 min is less than 1% by weight, less elution of the release layer 5 into the 3% aqueous tetramethyl ammonium hydroxide solution occurs. Therefore, solvent resistance (especially, solvent resistance to an aqueous tetramethyl ammonium hydroxide solution) can be improved. The weight loss rate of the release layer 5 can be controlled by the composition of a diamine to be used (the solubility of a diamine in the aqueous tetramethyl ammonium hydroxide solution), for example.

The increased amount of particles of 0.2 μm or more on the surface of a silicon wafer when the release layer 5 is bonded to the silicon wafer and then peeled off is preferably less than 10,000 particles/6 inch wafer, more preferably less than 9,000 particles/6 inch wafer, and further preferably less than 8,000 particles/6 inch wafer with respect to the amount before the sheet is bonded to the silicon wafer. The increased amount of particles is especially preferably less than 1,000 particles/6 inch wafer, less than 900 particles/6 inch wafer, or less than 800 particles/6 inch wafer with respect to the amount before the sheet is bonded to the silicon wafer. When the increased amount of particles of 0.2 μm or more on the surface of a silicon wafer when the release layer 5 is bonded to the silicon wafer and then peeled off is less than 10,000 particles/6 inch wafer with respect to the amount before the sheet is bonded to the silicon wafer, adhesive residue after peeling can be suppressed.

The forming material of the release layer 5 is not especially limited as long as the weight loss rate after the sheet is soaked in N-methyl-2-pyrrolidone (NMP) at 50° C. for 60 sec and dried at 150° C. for 30 min is 1.0% by weight or more. However, examples include a polyimide resin, a silicone resin, an acrylic resin, a fluororesin, an epoxy resin, a urethane resin, and a rubber resin.

The method of manufacturing a semiconductor device according to the present embodiment can adopt the same steps as those of the method of manufacturing a semiconductor device of the eighth aspect of the present invention except that the peeling step is different. Therefore, only the peeling step is explained below.

[Peeling Step]

The peeling step is preferably performed by using N-methyl-2-pyrrolidone (NMP) as a solvent and soaking the sheet in the solvent for 10 sec to 6,000 sec. The soaking time is more preferably 15 sec to 3,000 sec. Further, the temperature of the solvent in the peeling step is preferably −10° C. to 200° C., and more preferably 20° C. to 120° C.

Further, the wiring circuit board is preferably not exposed to heat of 260° C. or more in the steps after the mounting step. With this operation, melting of solder and the like can be suppressed.

One example of the method of manufacturing a semiconductor device according to the present embodiment is explained above. However, the method of manufacturing a semiconductor device of the ninth aspect of the present invention is not limited to the above-described example, and it can be appropriately modified in the range of gist of the ninth aspect of the present invention.

### Tenth Aspect of the Present Invention

In the following, points of the tenth aspect of the present invention that are different from those of the eighth aspect of the present invention are explained. The release layer of the tenth aspect of the present invention can exhibit the same characteristics as those of the release layer of the eighth aspect of the present invention besides the characteristics that are specially explained in this section of the tenth aspect of the present invention. The method of manufacturing a semiconductor device of the tenth aspect of the present invention can adopt the same steps as those of the method of manufacturing a semiconductor device of the eighth aspect of the present invention.

In the following, only the parts of one example of the embodiment of the tenth aspect of the present invention that differ from the embodiment according to the eighth aspect of the present invention will be explained.

The method of manufacturing a semiconductor device according to the present embodiment is a method of manufacturing a semiconductor device having a structure in which a semiconductor chip is mounted on a wiring circuit board, including at least the steps of: preparing a support having a release layer, forming a wiring circuit board on the release layer of the support, mounting a semiconductor chip to the wiring circuit board, and peeling the support off together with the release layer after the mounting with a surface of the release layer opposite to the support as an interface, in which the release layer has an imide group and at least a portion of the release layer has a constituent unit derived from a diamine having an ether structure.

The release layer 5 of the embodiment according to the eighth aspect of the present invention can be used as the release layer 5 except for the characteristics explained below.

The release layer 5 is constituted from a polyimide resin having an imide group and having a constituent unit derived from a diamine having an ether structure in at least a part thereof.

The polyimide resin can be generally obtained by performing imidization (dehydration condensation) of polyamic acid that is a precursor of the polyimide resin. A conventionally known method such as a heating imidization method, an azeotropic dehydration method, and a chemical imidization method can be adopted as the method of imidizing polyamic acid. Of these, a heating imidization method is preferable. When the heating imidization method is adopted, the heating treatment is preferably performed under an inert atmosphere such as under a nitrogen atmosphere or in vacuum to prevent deterioration caused by oxidation of the polyimide resin.

The polyamic acid can be obtained by charging an acid anhydride and a diamine (containing both a diamine having an ether structure and a diamine having no ether structure) in substantially equimolar ratio in an appropriately selected solvent and reacting them.

The polyimide resin preferably has a constituent unit derived from a diamine having an ether structure. The diamine having an ether structure is not especially limited as long as it is a compound having an ether structure and at least two ends having an amine structure. Among diamines having an ether structure, a diamine having a glycol skeleton is preferable. When the polyimide resin has a constituent unit derived from a diamine having an ether structure, especially a constituent unit derived from a diamine having a glycol skeleton, the release layer 5 can be heated to decrease the shear adhering strength.

Further, the elimination of the ether structure or the glycol skeleton from the resin that constitutes the release layer 5 can be confirmed, for example, by comparing the FT-IR (fourier transform infrared spectroscopy) spectra before and after the release layer 5 is heated at 300° C. for 30 min and confirming the decrease of the spectrum at 2,800 cm⁻¹ to 3,000 cm⁻¹ after the heating.

Examples of a diamine having a glycol skeleton include diamines having alkylene glycol such as a diamine having a polypropylene glycol structure and having an amino group on each end, a diamine having a polyethylene glycol structure and having an amino group on each end, and a diamine having a polytetramethylene glycol structure and having an amino group on each end. In addition, examples include diamines having a plurality of such glycol structures and having an amino group on each end.

The molecular weight of the diamine having an ether structure is preferably in a range of 100 to 5,000, and more preferably 150 to 4,800. When the molecular weight of the diamine having an ether structure is in a range of 100 to 5,000, the release layer 5 having high adhering strength at low temperature and having a peeling property at high temperature can be easily obtained.

In the formation of the polyimide resin, a diamine having no ether structure can be used together besides the diamine having an ether structure. Examples of a diamine having no ether structure include aliphatic diamines and aromatic diamines. The diamine having no ether structure is used together to control the adhesion with the adherend. The compounding ratio of a diamine having an ether structure to a diamine having no ether structure is preferably in a range of 100:0 to 10:90 by mole ratio, more preferably 100:0 to 20:80, and further preferably 99:1 to 30:70. When the compounding ratio of the diamine having an ether structure to the diamine having no ether structure is in a range of 100:0 to 10:90 by mole ratio, a superior thermal peeling property at a high temperature can be obtained.

Examples of the aliphatic diamines include ethylene diamine, hexamethylene diamine, 1,8-diaminooctane, 1,10-diaminodecane, 1,12-diaminododecane, 4,9-dioxa-1,12-diaminododecane, and 1,3-bis(3-aminopropyl)-1,1,3,3-tetramethyldicycloxane (α, ω-bisaminopropyltetramethyldicycloxane). The molecular weight of the aliphatic diamines is normally 50 to 1,000,000 and preferably 100 to 30,000.

Examples of the aromatic diamines include 4,4′-diaminodiphenylether, 3,4′-diaminodiphenylether, 3,3′-diaminodiphenylether, m-phenylene diamine, p-phenylene diamine, 4,4′-diaminodiphenylpropane, 3,3′-diaminodiphenylmethane, 4,4′-diaminodiphenylsulfide, 3,3′-diaminodiphenylsulfide, 4,4′-diaminodiphenylsulfone, 3,3′-diaminodiphenylsulfone, 1,4-bis(4-aminophenoxy)benzene, 1,3-bis(4-aminophenoxy)benzene, 1,3-bis(3-aminophenoxy)benzene, 1,3-bis(4-aminophenoxy)-2,2-dimethylpropane, and 4,4′-diaminobenzophenone. The molecular weight of the aromatic diamines is normally 50 to 1,000 and preferably 100 to 500. The molecular weight of the aliphatic diamine and the molecular weight of the aromatic diamine are measured by GPC (gel permeation chromatography), and are each a value (weight average molecular weight) calculated by polystyrene conversion.

Examples of the acid anhydride include 3,3′,4,4′-biphenyltetracarboxylic dianhydride, 2,2′,3,3′-biphenyltetracarboxylic dianhydride, 3,3′,4,4′-benzophenone tetracarboxylic dianhydride, 2,2′,3,3′-benzophenone tetracarboxylic dianhydride, 4,4′-oxydiphthalic dianhydride, 2,2-bis(2,3-dicarboxyphenyl) hexafluoropropane dianhydride, 2,2-bis(3,4-dicarboxyphenyl) hexafluoropropane dianhydride (6FDA), bis(2,3-dicarboxyphenyl)methane dianhydride, bis(3,4-dicarboxyphenyl)methane dianhydride, bis(2,3-dicarboxyphenyl) sulfone dianhydride, bis(3,4-dicarboxyphenyl) sulfone dianhydride, pyromellitic dianhydride, and ethylene glycol bistrimellitic dianhydride. These may be used either alone or in combination of two or more types.

Examples of the solvent that is used when reacting the acid anhydride with the diamine include N,N-dimethylacetamide, N-methyl-2-pyrrolidone, N,N-dimethylformamide, and cyclopentanone. These may be used either alone or in combination of a plurality of types. In addition, a nonpolar solvent such as toluene and xylene may be appropriately mixed to adjust the solubility of the raw material and resin.

The method of manufacturing a semiconductor device according to the present embodiment can adopt the same steps as those of the method of manufacturing a semiconductor device of the eighth aspect of the present invention except that the release layer explained above is used as the release layer. Therefore, the explanation is omitted here.

### EXAMPLES

Preferred examples of the present invention are explained in detail below. However, the materials, the compounded amounts, and the like described in the examples are not to limit the gist of the present invention only to these examples as long as there is no specific restrictive description.

### First Aspect of the Present Invention and Eighth Aspect of the Present Invention

Each of the following examples corresponds to the first aspect of the present invention and the eighth aspect of the present invention.

### Example 1

In an atmosphere under a nitrogen air flow, 12.95 g of polyetherdiamine (manufactured by Huntsman International LLC., D-2000, molecular weight: 1990.8), 7.88 g of 4,4′-diaminodiphenylether (DDE, molecular weight: 200.2), and 10.00 g of pyromellitic dianhydride (PMDA, molecular weight: 218.1) were mixed in 123.31 g of N, N-dimethylacetamide (DMAc) and reacted at 70° C. to obtain a polyamic acid solution A. After being cooled to room temperature (23° C.), the polyamic acid solution A was applied onto the mirror surface of an 8 inch silicon wafer with a spin coater, and dried at 90° C. for 20 min to obtain a support A with polyamic acid. A heat treatment was performed on the support A with polyamic acid at 300° C. for 2 hr under a nitrogen atmosphere to form a polyimide film (a thermally-detachable sheet) having a thickness of 30 μm, and a support A with a thermally-detachable sheet (a support A with a release layer) was obtained.

### Example 2

In an atmosphere under a nitrogen air flow, 12.32 g of polyetherdiamine (manufactured by Huntsman International LLC., D-400, molecular weight: 422.6), 3.34 g of 4,4′-diaminodiphenylether (DDE, molecular weight: 200.2), and 10.00 g of pyromellitic dianhydride (PMDA, molecular weight: 218.1) were mixed in 102.64 g of N,N-dimethylacetamide (DMAc) and reacted at 70° C. to obtain a polyamic acid solution B. After being cooled to room temperature (23° C.), the polyamic acid solution B was applied onto a SUS foil (thickness 38 μm) to a thickness of 50 μm after drying, and dried at 90° C. for 20 min to obtain a support B with polyamic acid. A heat treatment was performed on the support B with polyamic acid at 300° C. for 2 hr under a nitrogen atmosphere to form a polyimide film (a thermally-detachable sheet) having a thickness of 50 μm, and a support B with a thermally-detachable sheet (a support B with a release layer) was obtained.

### Example 3

In an atmosphere under a nitrogen air flow, 18.90 g of polyetherdiamine (manufactured by IHARA CHEMICAL INDUSTRY CO., LTD., ELASMER 1000, molecular weight:1229.7), 6.10 g of 4,4′-diaminodiphenylether (DDE, molecular weight:200.2), and 10.00 g of pyromellitic dianhydride (PMDA, molecular weight:218.1) were mixed in 64.41 g of N,N-dimethylacetamide (DMAc) and reacted at 70° C. to obtain a polyamic acid solution C. After being cooled to room temperature (23° C.), the polyamic acid solution C was applied onto an 8 inch glass wafer with a spin coater, and dried at 90° C. for 20 min to obtain a support C with polyamic acid. A heat treatment was performed on the support C with polyamic acid at 300° C. for 2 hr under a nitrogen atmosphere to form a polyimide film (a thermally-detachable sheet) having a thickness of 80 μm, and a support C with a thermally-detachable sheet (a support C with a release layer) was obtained.

### Comparative Example 1

In an atmosphere under a nitrogen air flow, 9.18 g of 4,4′-diaminodiphenylether (DDE, molecular weight:200.2) and 10.00 g of pyromellitic dianhydride (PMDA, molecular weight:218.1) were mixed in 364.42 g of N, N-dimethylacetamide (DMAc) and reacted at 70° C. to obtain a polyamic acid solution J. After being cooled to room temperature (23° C.), the polyamic acid solution J was applied onto the mirror surface of an 8 inch silicon wafer with a spin coater, and dried at 90° C. for 20 min to obtain a support J with polyamic acid. A heat treatment was performed on the support J with polyamic acid at 300° C. for 2 hr under a nitrogen atmosphere to form a polyimide film (a thermally-detachable sheet) having a thickness of 30 μm, and a support J with a thermally-detachable sheet (a support J with a release layer) was obtained.

(Measurement of the Shear Adhering Strength to a Silicon Wafer)

A 5 mm square (thickness 500 μm) silicon wafer chip was placed on a thermally-detachable sheet (a release layer) formed on a support (a silicon wafer, a SUS foil, or a glass wafer), and laminated under the condition of 60° C. and 10 mm/s. Then, the shear adhering strength of the thermally-detachable sheet (the release layer) to the silicon wafer chip was measured using a shear tester (manufactured by Nordson Corporation, Dage 4000). The shear test was performed in the following two conditions.

The results are shown in Table 1.

<Condition 1 of the Shear Test>

Stage Temperature: 200° C.

Time from placement of the test piece on the stage until the start of measurement of the shear adhering strength:
1 min

Measurement Speed: 500 μm/s

Measurement Gap: 100 μm

<Condition 2 of the Shear Test>

Stage Temperature: 260° C.

Time from placement of the test piece on the stage until the start of measurement of the shear adhering strength:
3 min

Measurement Speed: 500 μm/s

Measurement Gap: 100 μm

(Measurement of the Weight Loss Rate when the Sheet is Soaked in an Aqueous Tetramethyl Ammonium Hydroxide Solution)

First, the support was peeled off from the support with a thermally-detachable sheet according to the examples and the comparative example. Next, the peeled thermally-detachable sheet was cut into 100 mm square, and its weight was measured. Then, the sheet was soaked in a 3% aqueous tetramethyl ammonium hydroxide solution (TMAH) at 23° C. for 5 min. After the sheet was washed thoroughly with water, it was dried at 150° C. for 30 min. After that, the weight was measured and regarded as the weight after soaking.

The weight loss rate was obtained from the following formula. The results are shown in Table 1.

(Weight loss rate (% by weight))=[1−((weight after soaking)/(weight before soaking))]×100

(Measurement of the Weight Loss Rate when the Sheet is Soaked in N-Methyl-2-Pyrrolidone)

First, the support was peeled off from the support with a thermally-detachable sheet according to the examples and the comparative example. Next, the peeled thermally-detachable sheet was cut into 100 mm square, and its weight was measured. Then, the sheet was soaked in N-methyl-2-pyrrolidone (NMP) at 50° C. for 60 sec. After the sheet was washed thoroughly with water, it was dried at 150° C. for 30 min. After that, the weight was measured and regarded as the weight after soaking.

The weight loss rate was obtained from the following formula. The results are shown in Table 1.

(Weight loss rate (% by weight))=[((weight after soaking)/(weight before soaking))−1]×100

(Evaluation of the Adhesive Residue)

First, the support was peeled off from the support with a thermally-detachable sheet according to the examples and the comparative example. Next, each of the thermally-detachable sheets of the examples and the comparative example was processed into a piece having a diameter of 6 inches, and was laminated to a wafer having a diameter of 8 inches under the condition of 60° C. and 10 mm/s. After that, the sheet was left for 1 min, and peeled off. The number of particles of 0.2 μm or more on the surface of the 8 inch wafer was measured using a particle counter (SFS 6200, manufactured by KLA-Tencor Corporation). The evaluation was performed by marking the case in which the increased amount of particles after peeling was less than 1,000 particles/6 inch wafer with respect to the amount before the sheet was laminated as O, and the case in which it was 1,000 particles/6 inch wafer or more as X. The results are shown in Table 1.

(Peeling Temperature)

The thermally-detachable sheets of the examples and the comparative example were made into a size of 30 mm square, and a 10 mm square (thickness: 2 mm) glass was bonded onto the thermally-detachable sheets using a laminator. Using this sample, the temperature at which the glass is peeled off from the thermally-detachable sheet was confirmed by increasing the temperature under the condition of a temperature rise rate of 4° C./min and a measurement temperature of 20° C. to 350° C. with a high temperature observation apparatus (trade name: SK-5000) manufactured by SANYO SEIKO CO., LTD. The results are shown in Table 1.

(Gas Visual Temperature)

The thermally-detachable sheets of the examples and the comparative example were made into a size of 30 mm square, and a 10 mm square (thickness: 2 mm) glass was bonded onto the thermally-detachable sheets using a laminator. Using this sample, the temperature at which white smoke was generated was confirmed by increasing the temperature under the condition of a temperature rise rate of 4° C./min and a measurement temperature of 20° C. to 350° C. with a high temperature observation apparatus (trade name: SK-5000) manufactured by SANYO SEIKO CO., LTD. The results are shown in Table 1.

(Surface Hardness)

A load-unload test was performed on the thermally-detachable sheets of the examples and the comparative example at a load of 0.5 mN using a hardness meter (trade name: DUH-210) manufactured by Shimadzu Corporation to perform the measurement of the surface hardness. The results are shown in Table 1.

(Dynamic Hardness)

A load-unload test was performed on the thermally-detachable sheets of the examples and the comparative example at a load of 0.5 mN using a hardness meter (trade name: DUH-210) manufactured by Shimadzu Corporation and an indenter (trade name: Triangular 115, manufactured by Shimadzu Corporation) to perform the measurement of the dynamic hardness.

The results are shown in Table 1.

TABLE 1

| | | | | Compar- |
|---|---|---|---|---|
| | Exam- | Exam- | Exam- | ative |
| | ple 1 | ple 2 | ple 3 | Example 1 |
| Shear Adhering Strength | 1.06 | 8.50 | 1.69 | No |
| at 200° C. (kg/5 × 5 mm) | | | | Adhesion |
| Shear Adhering Strength | 0.15 | 0.20 | 0.09 | No |
| at 260° C. (kg/5 × 5 mm) | | | | Adhesion |
| TMAH Weight Loss Rate | 0.40 | 0.20 | 0.16 | 0.00 |
| (% by weight) | | | | |
| NMP Weight Loss Rate | 1.30 | 1.19 | 1.13 | 0.00 |
| (% by weight) | | | | |
| Evaluation of Adhesive Residue | ◯ | ◯ | ◯ | — |
| Peeling Temperature (° C.) | 247 | 268 | 350 | No |
| | | | | Adhesion |
| Gas Visual Temperature (° C.) | 242 | 260 | 295 | No |
| | | | | Adhesion |
| Surface Hardness (GPa) | 1.5 | 0.6 | 3.7 | 20.0 |
| Dynamic Hardness | 2.8 | 1.0 | 4.2 | 58.0 |
| Evaluation of Manufacture of | ◯ | ◯ | ◯ | X |
| Semiconductor Device | | | | |

(Result)

The shear adhering strength of the thermally-detachable sheet according to the examples to a silicon wafer at 200° C. after it was kept at that temperature for 1 min was 0.25 kg/5×5 mm or more, and the shear adhering strength to a silicon wafer at 260° C. after it was kept at that temperature for 3 min was less than 0.25 kg/5×5 mm.

(Evaluation of Manufacture of a Semiconductor Device)

First, a semiconductor device was manufactured as follows.

[Formation of a Base Insulating Layer]

A base insulating layer was formed on the support with a release layer of the examples and the comparative example. Specifically, a solution containing a photosensitive polyimide and polybenzoxazole (PBO) was applied to a thickness after curing (after imidization) of 10 um. After that, drying of the solvent was performed at 150° C. for 10 min, and light exposure was performed with a prescribed pattern. The amount of light exposure was 1,000 mJ/cm² in an i-line (a spectrum line of mercury at a wavelength of 365 nm). Next, post exposure baking (PEB) was performed at 150° C. for 1 hr. After that, the resultant was developed for 60 sec under the condition of 50° C. using a 3% aqueous tetramethyl ammonium hydroxide solution (TMAH) to form a pattern. After that, imidization was performed at 350° C. for 3 hr under a nitrogen atmosphere to form the base insulating layer.

[Formation of the Seed Film]

A chromium (Cr) film of 30 nm was formed on the base insulating layer by sputtering. On top of that, a copper (Cu) film of 80 nm was formed by sputtering.

[Formation of the Resist]

Next, a dry film resist was formed. The thickness was 20 μm. Then, light exposure was performed to form a prescribed pattern. The amount of light exposure was 300 mJ/cm² in an i line (a spectrum line of mercury at a wavelength of 365 nm). After that, the resultant was developed for 60 sec under the condition of 50° C. using an alkali solution (10% NaOH) to perform patterning.

[Formation of the Wiring]

Copper plating that corresponds to the formed resist was formed by electrolytic plating. The thickness of the copper plating was 10 μm.

[Peeling of the Resist]

The resist was peeled off by soaking in an alkali solution (10% KOH) of 50° C. for 60 sec.

[Peeling of the Seed Film]

The Cu sputtering film was peeled off by soaking in sulfuric acid (10%) at room temperature (23° C.) for 30 sec. Next, the Cr sputtering film was peeled off by soaking in an aqueous potassium ferricyanide solution (10%) of 50° C. for 60 sec.

[Formation of a Cover Coat (the Adhesive Layer)]

An epoxy resin was applied to a thickness of 10 lam after curing, and dried at 100° C. for 10 min. Then, light exposure was performed to form a prescribed pattern. The amount of light exposure was 300 mJ/cm² in an i line (a spectrum line of mercury at a wavelength of 365 nm). After that, the resultant was developed for 60 sec under the condition of 50° C. using an alkali solution (10% NaOH) to perform patterning. After that, the epoxy resin was cured by heating at 150° C. for 1 hr.

[Formation of the Conductor Portion for Connection (the Terminals)]

A nickel (Ni) layer having a thickness of 1 μm and then a gold (Au) layer having a thickness of 0.5 μm were formed on the portion where a terminal was to be formed. With this operation, a wiring circuit board having a conductor portion for connection (the terminals) was obtained.

[Mounting]

A semiconductor chip having an electrode that corresponds to the formed conductor portion for connection (terminals) was mounted on the wiring circuit board. After that, the resultant was kept under a temperature condition of 260° C. for 3 min.

(Evaluation)

The peeling of the wiring circuit board from the support was attempted. The evaluation was performed by marking the case in which the support was peeled off together with the release layer as the base insulating layer and the release layer as an interface as O, and the case in which it was not peeled off as X. The results are shown in Table 1.

### Second Aspect of the Present Invention and Ninth Aspect of the Present Invention

Each of the following examples corresponds to the second aspect of the present invention and the ninth aspect of the present invention.

### Example 1

In an atmosphere under a nitrogen air flow, 10.34 g of polyetherdiamine (manufactured by Huntsman International LLC., D-400, molecular weight: 422.6), 4.28 g of 4,4′-diaminodiphenylether (DDE, molecular weight: 200.2), and 10.00 g of pyromellitic dianhydride (PMDA, molecular weight: 218.1) were mixed in 98.49 g of N,N-dimethylacetamide (DMAc) and reacted at 70° C. to obtain a polyamic acid solution A. After being cooled to room temperature (23° C.), the polyamic acid solution A was applied onto the mirror surface of an 8 inch silicon wafer with a spin coater, and dried at 90° C. for 20 min to obtain a support A with polyamic acid. A heat treatment was performed on the support A with polyamic acid at 300° C. for 2 hr under a nitrogen atmosphere to form a polyimide film (a solvent-detachable sheet) having a thickness of 35 μm, and a support A with a solvent-detachable sheet (a support A with a release layer) was obtained.

### Example 2

In an atmosphere under a nitrogen air flow, 15.39 g of polyetherdiamine (manufactured by IHARA CHEMICAL INDUSTRY CO., LTD., ELASMER 1000, molecular weight: 1229.7), 6.67 g of 4,4′-diaminodiphenylether (DDE, molecular weight: 200.2), and 10.00 g of pyromellitic dianhydride (PMDA, molecular weight: 218.1) were mixed in 66.70 g of N,N-dimethylacetamide (DMAc) and reacted at 70° C. to obtain a polyamic acid solution B. After being cooled to room temperature (23° C.), the polyamic acid solution B was applied onto a SUS foil (thickness 38 μm) to a thickness of 100 μm after drying, and dried at 90° C. for 20 min to obtain a support B with polyamic acid. A heat treatment was performed on the support B with polyamic acid at 300° C. for 2 hr under a nitrogen atmosphere to form a polyimide film (a solvent-detachable sheet) having a thickness of 100 μm, and a support B with a solvent-detachable sheet (a support B with a release layer) was obtained.

### Example 3

In an atmosphere under a nitrogen air flow, 21.27 g of polyetherdiamine (manufactured by Huntsman International LLC., D-4000, molecular weight: 4023.5), 8.12 g of 4,4′-diaminodiphenylether (DDE, molecular weight: 200.2), and 10.00 g of pyromellitic dianhydride (PMDA, molecular weight: 218.1) were mixed in 157.58 g of N,N-dimethylacetamide (DMAc) and reacted at 70° C. to obtain a polyamic acid solution C. After being cooled to room temperature (23° C.), the polyamic acid solution C was applied onto an 8 inch glass wafer with a spin coater, and dried at 90° C. for 20 min to obtain a support C with polyamic acid. A heat treatment was performed on the support C with polyamic acid at 300° C. for 2 hr under a nitrogen atmosphere to form a polyimide film (a solvent-detachable sheet) having a thickness of 30 μm, and a support C with a solvent-detachable sheet (a support C with a release layer) was obtained.

### Comparative Example 1

In an atmosphere under a nitrogen air flow, 9.18 g of 4,4′-diaminodiphenylether (DDE, molecular weight: 200.2) and 10.00 g of pyromellitic dianhydride (PMDA, molecular weight: 218.1) were mixed in 364.42 g of N,N-dimethylacetamide (DMAc) and reacted at 70° C. to obtain a polyamic acid solution J. After being cooled to room temperature (23° C.), the polyamic acid solution J was applied onto the mirror surface of an 8 inch silicon wafer with a spin coater, and dried at 90° C. for 20 min to obtain a support J with polyamic acid. A heat treatment was performed on the support J with polyamic acid at 300° C. for 2 hr under a nitrogen atmosphere to form a polyimide film (a solvent-detachable sheet) having a thickness of 30 μm, and a support J with a solvent-detachable sheet (a support J with a release layer) was obtained.

(Measurement of the Shear Adhering Strength to a Silicon Wafer)

A 5 mm square (thickness 500 μm) silicon wafer chip was placed on a solvent-detachable sheet (a release layer) formed on a support (a silicon wafer, a SUS foil, or a glass wafer), and laminated under the condition of 60° C. and 10 mm/s. Then, the shear adhering strength of the solvent-detachable sheet (the release layer) to the silicon wafer chip was measured using a shear tester (manufactured by Nordson Corporation, Dage 4000). The shear test was performed in the following two conditions. The results are shown in Table 2.

<Condition 1 of the Shear Test>

Stage Temperature: 200° C.

Time from placement of the test piece on the stage until the start of measurement of the shear adhering strength:
1 min

Measurement Speed: 500 μm/s

Measurement Gap: 100 μm

<Condition 2 of the Shear Test>

Stage Temperature: 260° C.

Time from placement of the test piece on the stage until the start of measurement of the shear adhering strength:
3 min

Measurement Speed: 500 μm/s

Measurement Gap: 100 μm

(Measurement of the Weight Loss Rate when the Sheet is Soaked in an Aqueous Tetramethyl Ammonium Hydroxide Solution)

First, the support was peeled off from the support with a solvent-detachable sheet according to the examples and the comparative example. Next, the peeled solvent-detachable sheet was cut into 100 mm square, and its weight was measured. Then, the sheet was soaked in a 3% aqueous tetramethyl ammonium hydroxide solution (TMAH) at 23° C. for 5 min. After the sheet was washed thoroughly with water, it was dried at 150° C. for 30 min. After that, the weight was measured and regarded as the weight after soaking.

The weight loss rate was obtained from the following formula. The results are shown in Table 2.

(Weight loss rate (% by weight))=[1−((weight after soaking)/(weight before soaking))]×100

(Measurement of the Weight Loss Rate when the Sheet is Soaked in N-Methyl-2-Pyrrolidone)

First, the support was peeled off from the support with a solvent-detachable sheet according to the examples and the comparative example. Next, the peeled solvent-detachable sheet was cut into 100 mm square, and its weight was measured. Then, the sheet was soaked in N-methyl-2-pyrrolidone (NMP) at 50° C. for 60 sec. After the sheet was washed thoroughly with water, it was dried at 150° C. for 30 min. After that, the weight was measured and regarded as the weight after soaking.

The weight loss rate was obtained from the following formula. The results are shown in Table 2.

(Weight loss rate (% by weight))=[((weight after soaking)/(weight before soaking))−1]×100

(Evaluation of the Adhesive Residue)

First, the support was peeled off from the support with a solvent-detachable sheet according to the examples and the comparative example. Next, each of the solvent-detachable sheets of the examples and the comparative example was processed into a piece having a diameter of 6 inches, and was laminated to a wafer having a diameter of 8 inches under the condition of 60° C. and 10 mm/s. After that, the sheet was left for 1 min, and peeled off. The number of particles of 0.2 μm or more on the surface of the 8 inch wafer was measured using a particle counter (SFS 6200, manufactured by KLA-Tencor Corporation). The evaluation was performed by marking the case in which the increased amount of particles after peeling was less than 1,000 particles/6 inch wafer with respect to the amount before the sheet was laminated as O, and the case in which it was 1,000 particles/6 inch wafer or more as X. The results are shown in Table 2.

(Peeling Temperature)

The solvent-detachable sheets of the examples and the comparative example were made into a size of 30 mm square, and a 10 mm square (thickness: 2 mm) glass was bonded onto the solvent-detachable sheets using a laminator. Using this sample, the temperature at which the glass is peeled off from the solvent-detachable sheet was confirmed by increasing the temperature under the condition of a temperature rise rate of 4° C./min and a measurement temperature of 20° C. to 350° C. with a high temperature observation apparatus (trade name: SK-5000) manufactured by SANYO SEIKO CO., LTD. The results are shown in Table 2.

(Gas Visual Temperature)

The solvent-detachable sheets of the examples and the comparative example were made into a size of 30 mm square, and a 10 mm square (thickness: 2 mm) glass was bonded onto the solvent-detachable sheets using a laminator. Using this sample, the temperature at which white smoke was generated was confirmed by increasing the temperature under the condition of a temperature rise rate of 4° C./min and a measurement temperature of 20° C. to 350° C. with a high temperature observation apparatus (trade name:SK-5000) manufactured by SANYO SEIKO CO., LTD. The results are shown in Table 2.

(Surface Hardness)

A load-unload test was performed on the solvent-detachable sheets of the examples and the comparative example at a load of 0.5 mN using a hardness meter (trade name: DUH-210) manufactured by Shimadzu Corporation to perform the measurement of the surface hardness. The results are shown in Table 2.

(Dynamic Hardness)

A load-unload test was performed on the solvent-detachable sheets of the examples and the comparative example at a load of 0.5 mN using a hardness meter (trade name: DUH-210) manufactured by Shimadzu Corporation and an indenter (trade name: Triangular 115, manufactured by Shimadzu Corporation) to perform the measurement of the dynamic hardness. The results are shown in Table 2.

TABLE 2

| | | | | Compar- |
|---|---|---|---|---|
| | Exam- | Exam- | Exam- | ative |
| | ple 1 | ple 2 | ple 3 | Example 1 |
| Shear Adhering Strength | 2.00 | 1.54 | 1.81 | No |
| at 200° C. (kg/5 × 5 mm) | | | | Adhesion |
| Shear Adhering Strength | 0.20 | 0.11 | 0.19 | No |
| at 260° C. (kg/5 × 5 mm) | | | | Adhesion |
| TMAH Weight Loss Rate | 0.20 | 0.15 | 0.50 | 0.00 |
| (% by weight) | | | | |
| NMP Weight Loss Rate | 1.00 | 1.09 | 1.81 | 0.00 |
| (% by weight) | | | | |
| Evaluation of Adhesive Residue | ◯ | ◯ | ◯ | — |
| Peeling Temperature (° C.) | 320 | 338 | 242 | No |
| | | | | Adhesion |
| Gas Visual Temperature (° C.) | 272 | 293 | 242 | No |
| | | | | Adhesion |
| Surface Hardness (GPa) | 3.3 | 3.6 | 0.9 | 20.0 |
| Dynamic Hardness | 2.9 | 4.2 | 2.6 | 58.0 |
| Evaluation of Manufacture of | ◯ | ◯ | ◯ | X |
| Semiconductor Device | | | | |

(Result)

The weight loss rate of the thermally-detachable sheet according to the examples after the sheet is soaked in N-methyl-2-pyrrolidone at 50° C. for 60 sec and dried at 150° C. for 30 min was 1.0% by weight or more.

(Evaluation of Manufacture of a Semiconductor Device)

First, a semiconductor device was manufactured as follows.

[Formation of a Base Insulating Layer]

A base insulating layer was formed on the support with a release layer of the examples and the comparative example. Specifically, a solution containing a photosensitive polyimide and polybenzoxazole (PBO) was applied to a thickness after curing (after imidization) of 10 um. After that, drying of the solvent was performed at 150° C. for 10 min, and light exposure was performed with a prescribed pattern. The amount of light exposure was 1,000 mJ/cm² in an i-line (a spectrum line of mercury at a wavelength of 365 nm). Next, post exposure baking (PEB) was performed at 150° C. for 1 hr. After that, the resultant was developed for 60 sec under the condition of 50° C. using a 3% aqueous tetramethyl ammonium hydroxide solution (TMAH) to form a pattern. After that, imidization was performed at 350° C. for 3 hr under a nitrogen atmosphere to form the base insulating layer.

[Formation of the Seed Film]

A chromium (Cr) film of 30 nm was formed on the base insulating layer by sputtering. On top of that, a copper (Cu) film of 80 nm was formed by sputtering.

[Formation of the Resist]

Next, a dry film resist was formed. The thickness was 20 μm. Then, light exposure was performed to form a prescribed pattern. The amount of light exposure was 300 mJ/cm² in an i line (a spectrum line of mercury at a wavelength of 365 nm). After that, the resultant was developed for 60 sec under the condition of 50° C. using an alkali solution (10% NaOH) to perform patterning.

[Formation of the Wiring]

Copper plating that corresponds to the formed resist was formed by electrolytic plating. The thickness of the copper plating was 10 μm.

[Peeling of the Resist]

The resist was peeled off by soaking in an alkali solution (10% KOH) of 50° C. for 60 sec.

[Peeling of the Seed Film]

The Cu sputtering film was peeled off by soaking in sulfuric acid (10%) at room temperature (23° C.) for 30 sec. Next, the Cr sputtering film was peeled off by soaking in an aqueous potassium ferricyanide solution (10%) of 50° C. for 60 sec.

[Formation of a Cover Coat (the Adhesive Layer)]

An epoxy resin was applied to a thickness of 10 μm after curing, and dried at 100° C. for 10 min. Then, light exposure was performed to form a prescribed pattern. The amount of light exposure was 300 mJ/cm² in an i line (a spectrum line of mercury at a wavelength of 365 nm). After that, the resultant was developed for 60 sec under the condition of 50° C. using an alkali solution (10% NaOH) to perform patterning. After that, the epoxy resin was cured by heating at 150° C. for 1 hr.

[Formation of the Conductor Portion for Connection (the Terminals)]

A nickel (Ni) layer having a thickness of 1 μm and then a gold (Au) layer having a thickness of 0.5 μm were formed on the portion where a terminal was to be formed. With this operation, a wiring circuit board having a conductor portion for connection (the terminals) was obtained.

[Mounting]

A semiconductor chip having an electrode that corresponds to the formed conductor portion for connection (terminals) was mounted on the wiring circuit board. After that, the resultant was soaked in N-methyl-2-pyrrolidone (NMP) at 50° C. for 600 sec.

(Evaluation)

The peeling of the wiring circuit board from the support was attempted. The evaluation was performed by marking the case in which the support was peeled off together with the release layer as the base insulating layer and the release layer as an interface as O, and the case in which it was not peeled off as X. The results are shown in Table 2.

### Third Aspect of the Present Invention and Tenth Aspect of the Present Invention

Each of the following examples corresponds to the third aspect of the present invention and the tenth aspect of the present invention.

### Example 1

In an atmosphere under a nitrogen air flow, 13.41 g of polyetherdiamine (manufactured by Huntsman International LLC., D-4000, molecular weight: 4023.5), 8.51 g of 4,4′-diaminodiphenylether (DDE, molecular weight: 200.2), and 10.00 g of pyromellitic dianhydride (PMDA, molecular weight: 218.1) were mixed in 127.69 g of N,N-dimethylacetamide (DMAc) and reacted at 70° C. to obtain a polyamic acid solution A. After being cooled to room temperature (23° C.), the polyamic acid solution A was applied onto the mirror surface of an 8 inch silicon wafer with a spin coater, and dried at 90° C. for 20 min to obtain a support A with polyamic acid. A heat treatment was performed on the support A with polyamic acid at 300° C. for 2 hr under a nitrogen atmosphere to form a polyimide film (a thermally-detachable sheet) having a thickness of 30 μm, and a support A with a thermally-detachable sheet (a support A with a release layer) was obtained.

### Example 2

In an atmosphere under a nitrogen air flow, 16.20 g of polyetherdiamine (manufactured by Huntsman International LLC., D-2000, molecular weight: 1990.8), 7.55 g of 4,4′-diaminodiphenylether (DDE, molecular weight: 200.2), and 10.00 g of pyromellitic dianhydride (PMDA, molecular weight: 218.1) were mixed in 135.00 g of N,N-dimethylacetamide (DMAc) and reacted at 70° C. to obtain a polyamic acid solution B. After being cooled to room temperature (23° C.), the polyamic acid solution B was applied onto a SUS foil (thickness 50 μm) to a thickness of 30 μm after drying, and dried at 90° C. for 20 min to obtain a support B with polyamic acid. A heat treatment was performed on the support B with polyamic acid at 300° C. for 2 hr under a nitrogen atmosphere to form a polyimide film (a thermally-detachable sheet) having a thickness of 30 μm, and a support B with a thermally-detachable sheet (a support B with a release layer) was obtained.

### Example 3

In an atmosphere under a nitrogen air flow, 14.47 g of polyetherdiamine (manufactured by Huntsman International LLC., D-400, molecular weight: 422.6), 2.33 g of 4,4′-diaminodiphenylether (DDE, molecular weight: 200.2), and 10.00 g of pyromellitic dianhydride (PMDA, molecular weight: 218.1) were mixed in 107.17 g of N,N-dimethylacetamide (DMAc) and reacted at 70° C. to obtain a polyamic acid solution C. After being cooled to room temperature (23° C.), the polyamic acid solution C was applied onto a nickel foil (thickness 100 μm) to a thickness of 50 μm after drying, and dried at 90° C. for 20 min to obtain a support C with polyamic acid. A heat treatment was performed on the support C with polyamic acid at 300° C. for 2 hr under a nitrogen atmosphere to form a polyimide film (a thermally-detachable sheet) having a thickness of 50 μm, and a support C with a thermally-detachable sheet (a support C with a release layer) was obtained.

(Confirmation of the Existence of an Imide Group)

The existence of an imide group in the thermally-detachable sheet (the release layer) according to the examples was confirmed by analyzing the existence of an absorption peak derived from an imide group by FT-IR. As a result, the absorption peak derived from an imide group was confirmed in the thermally-detachable sheet of the examples.

(Confirmation of the Elimination of the Ether Structure Portion by Heating)

The confirmation of the ether structure portion of the thermally-detachable sheets (the release layer) according to the examples by heating was performed by FT-IR. Specifically, it was determined that there was the elimination of the ether structure portion by comparing the FT-IR (fourier transform infrared spectroscopy) spectra before and after the thermally-detachable sheet was heated at 300° C. for 30 min when the spectrum at 2,800 cm⁻¹ to 3,000 cm⁻¹ was decreased after the heating, and it was determined that there was no elimination of the ether structure portion when the spectrum was not decreased. As a result, the elimination of the ether structure portion by heating was confirmed in the thermally-detachable sheets of the examples.

(Measurement of the Shear Adhering Strength to a Silicon Wafer)

A 5 mm square (thickness 500 μm) silicon wafer chip was placed on a thermally-detachable sheet (a release layer) formed on a support (a silicon wafer, a SUS foil, or a glass wafer), and laminated under the condition of 60° C. and 10 mm/s. Then, the shear adhering strength of the thermally-detachable sheet (the release layer) to the silicon wafer chip was measured using a shear tester (manufactured by Nordson Corporation, Dage 4000). The shear test was performed in the following two conditions. The results are shown in Table 3.

<Condition 1 of the Shear Test>

Stage Temperature: 200° C.

Time from placement of the test piece on the stage until the start of measurement of the shear adhering strength:
1 min

Measurement Speed: 500 μm/s

Measurement Gap: 100 μm

<Condition 2 of the Shear Test>

Stage Temperature: 260° C.

Time from placement of the test piece on the stage until the start of measurement of the shear adhering strength:
3 min

Measurement Speed: 500 μm/s

Measurement Gap: 100 μm

(Measurement of the Weight Loss Rate when the Sheet is Soaked in an Aqueous Tetramethyl Ammonium Hydroxide Solution)

First, the support was peeled off from the support with a thermally-detachable sheet according to the examples. Next, the peeled thermally-detachable sheet was cut into 100 mm square, and its weight was measured. Then, the sheet was soaked in a 3% aqueous tetramethyl ammonium hydroxide solution (TMAH) at 23° C. for 5 min. After the sheet was washed thoroughly with water, it was dried at 150° C. for 30 min. After that, the weight was measured and regarded as the weight after soaking.

The weight loss rate was obtained from the following formula. The results are shown in Table 3.

(Weight loss rate (% by weight))=[1−((weight after soaking)/(weight before soaking))]×100

(Measurement of the Weight Loss Rate when the Sheet is Soaked in N-Methyl-2-Pyrrolidone)

First, the support was peeled off from the support with a thermally-detachable sheet according to the examples. Next, the peeled thermally-detachable sheet was cut into 100 mm square, and its weight was measured. Then, the sheet was soaked in N-methyl-2-pyrrolidone (NMP) at 50° C. for 60 sec. After the sheet was washed thoroughly with water, it was dried at 150° C. for 30 min. After that, the weight was measured and regarded as the weight after soaking.

The weight loss rate was obtained from the following formula. The results are shown in Table 3.

(Weight loss rate (% by weight))=[((weight after soaking)/(weight before soaking))−1]×100

(Evaluation of the Adhesive Residue)

First, the support was peeled off from the support with a thermally-detachable sheet according to the examples. Next, each of the thermally-detachable sheets of the examples was processed into a piece having a diameter of 6 inches, and was laminated to a wafer having a diameter of 8 inches under the condition of 60° C. and 10 mm/s. After that, the sheet was left for 1 min, and peeled off. The number of particles of 0.2 μm or more on the surface of the 8 inch wafer was measured using a particle counter (SFS 6200, manufactured by KLA-Tencor Corporation). The evaluation was performed by marking the case in which the increased amount of particles after peeling was less than 1,000 particles/6 inch wafer with respect to the amount before the sheet was laminated as O, and the case in which it was 1,000 particles/6 inch wafer or more as X. The results are shown in Table 3.

(Peeling Temperature)

The thermally-detachable sheets of the examples were made into a size of 30 mm square, and a 10 mm square (thickness: 2 mm) glass was bonded onto the thermally-detachable sheets using a laminator. Using this sample, the temperature at which the glass is peeled off from the thermally-detachable sheet was confirmed by increasing the temperature under the condition of a temperature rise rate of 4° C./min and a measurement temperature of 20° C. to 350° C. with a high temperature observation apparatus (trade name:SK-5000) manufactured by SANYO SEIKO CO., LTD. The results are shown in Table 3.

(Gas Visual Temperature)

The thermally-detachable sheets of the examples were made into a size of 30 mm square, and a 10 mm square (thickness: 2 mm) glass was bonded onto the thermally-detachable sheets using a laminator. Using this sample, the temperature at which white smoke was generated was confirmed by increasing the temperature under the condition of a temperature rise rate of 4° C./min and a measurement temperature of 20° C. to 350° C. with a high temperature observation apparatus (trade name: SK-5000) manufactured by SANYO SEIKO CO., LTD. The results are shown in Table 3.

(Surface Hardness)

A load-unload test was performed on the thermally-detachable sheets of the examples at a load of 0.5 mN using a hardness meter (trade name: DUH-210) manufactured by Shimadzu Corporation to perform the measurement of the surface hardness. The results are shown in Table 3.

(Dynamic Hardness)

A load-unload test was performed on the thermally-detachable sheets of the examples at a load of 0.5 mN using a hardness meter (trade name: DUH-210) manufactured by Shimadzu Corporation and an indenter (trade name: Triangular 115, manufactured by Shimadzu Corporation) to perform the measurement of the dynamic hardness. The results are shown in Table 3.

TABLE 3

| | Exam- | Exam- | Exam- |
|---|---|---|---|
| | ple 1 | ple 2 | ple 3 |
| Shear Adhering Strength at 200° C. | 0.80 | 1.79 | 15.02 |
| (kg/5 × 5 mm) | | | |
| Shear Adhering Strength at 260° C. | 0.20 | 0.20 | 0.20 |
| (kg/5 × 5 mm) | | | |
| TMAH Weight Loss Rate (% by weight) | 0.70 | 0.40 | 0.20 |
| NMP Weight Loss Rate (% by weight) | 1.21 | 1.49 | 1.20 |
| Evaluation of Adhesive Residue | ◯ | ◯ | ◯ |
| Peeling Temperature (° C.) | 201 | 280 | 273 |
| Gas Visual Temperature (° C.) | 241 | 238 | 261 |
| Surface Hardness (GPa) | 1.7 | 0.6 | 0.6 |
| Dynamic Hardness | 3.6 | 2.0 | 1.0 |
| Evaluation of Manufacture of | ◯ | ◯ | ◯ |
| Semiconductor Device | | | |

(Result)

The shear adhering strength of the thermally-detachable sheet according to the examples to a silicon wafer at 200° C. after it was kept at that temperature for 1 min was high, and the shear adhering strength to a silicon wafer at 260° C. after it was kept at that temperature for 3 min was largely decreased compared to the case in which it was kept at 200° C. for 1 min.

(Evaluation of Manufacture of a Semiconductor Device)

First, a semiconductor device was manufactured as follows.

[Formation of a Base Insulating Layer]

A base insulating layer was formed on the support with a release layer of the examples. Specifically, a solution containing a photosensitive polyimide and polybenzoxazole (PBO) was applied to a thickness after curing (after imidization) of 10 um. After that, drying of the solvent was performed at 150° C. for 10 min, and light exposure was performed with a prescribed pattern. The amount of light exposure was 1,000 mJ/cm² in an i-line (a spectrum line of mercury at a wavelength of 365 nm). Next, post exposure baking (PEB) was performed at 150° C. for 1 hr. After that, the resultant was developed for 60 sec under the condition of 50° C. using a 3% aqueous tetramethyl ammonium hydroxide solution (TMAH) to form a pattern. After that, imidization was performed at 350° C. for 3 hr under a nitrogen atmosphere to form the base insulating layer.

[Formation of the Seed Film]

A chromium (Cr) film of 30 nm was formed on the base insulating layer by sputtering. On top of that, a copper (Cu) film of 80 nm was formed by sputtering.

[Formation of the Resist]

Next, a dry film resist was formed. The thickness was 20 μm. Then, light exposure was performed to form a prescribed pattern. The amount of light exposure was 300 mJ/cm² in an i line (a spectrum line of mercury at a wavelength of 365 nm). After that, the resultant was developed for 60 sec under the condition of 50° C. using an alkali solution (10% NaOH) to perform patterning.

[Formation of the Wiring]

Copper plating that corresponds to the formed resist was formed by electrolytic plating. The thickness of the copper plating was 10 μm.

[Peeling of the Resist]

The resist was peeled off by soaking in an alkali solution (10% KOH) of 50° C. for 60 sec.

[Peeling of the Seed Film]

The Cu sputtering film was peeled off by soaking in sulfuric acid (10%) at room temperature (23° C.) for 30 sec. Next, the Cr sputtering film was peeled off by soaking in an aqueous potassium ferricyanide solution (10%) of 50° C. for 60 sec.

[Formation of a Cover Coat (the Adhesive Layer)]

An epoxy resin was applied to a thickness of 10 μm after curing, and dried at 100° C. for 10 min. Then, light exposure was performed to form a prescribed pattern. The amount of light exposure was 300 mJ/cm² in an i line (a spectrum line of mercury at a wavelength of 365 nm). After that, the resultant was developed for 60 sec under the condition of 50° C. using an alkali solution (10% NaOH) to perform patterning. After that, the epoxy resin was cured by heating at 150° C. for 1 hr.

[Formation of the Conductor Portion for Connection (the Terminals)]

A nickel (Ni) layer having a thickness of 1 μm and then a gold (Au) layer having a thickness of 0.5 μm were formed on the portion where a terminal was to be formed. With this operation, a wiring circuit board having a conductor portion for connection (the terminals) was obtained.

[Mounting]

A semiconductor chip having an electrode that corresponds to the formed conductor portion for connection (terminals) was mounted on the wiring circuit board. After that, the resultant was kept under a temperature condition of 260° C. for 3 min.

(Evaluation)

The peeling of the wiring circuit board from the support was attempted. The evaluation was performed by marking the case in which the support was peeled off together with the release layer as the base insulating layer and the release layer as an interface as O, and the case in which it was not peeled off as X. The results are shown in Table 3.

### Fourth Aspect of the Present Invention

Each of the following examples corresponds to the fourth aspect of the present invention.

### Example 1

In an atmosphere under a nitrogen air flow, 13.95 g of polyetherdiamine (manufactured by Huntsman International LLC., D-4000, molecular weight: 4023.5), 8.49 g of 4,4′-diaminodiphenylether (DDE, molecular weight: 200.2), and 10.0 g of pyromellitic dianhydride (PMDA, molecular weight: 218.1) were mixed in 129.73 g of N,N-dimethylacetamide (DMAc) and reacted at 70° C. to obtain a polyamic acid solution A. After being cooled to room temperature (23° C.), the polyamic acid solution A was applied onto the mirror surface of an 8 inch silicon wafer with a spin coater, and dried at 90° C. for 20 min to obtain a support A with polyamic acid. A heat treatment was performed on the support A with polyamic acid at 300° C. for 2 hr under a nitrogen atmosphere to form a polyimide film (a thermally-detachable sheet) having a thickness of 30 μm, and a support A with a thermally-detachable sheet was obtained.

### Example 2

In an atmosphere under a nitrogen air flow, 15.62 g of polyetherdiamine (manufactured by Huntsman International LLC., D-2000, molecular weight: 1990.8), 7.61 g of 4,4′-diaminodiphenylether (DDE, molecular weight: 200.2), and 10.0 g of pyromellitic dianhydride (PMDA, molecular weight:218.1) were mixed in 132.9 g of N,N-dimethylacetamide (DMAc) and reacted at 70° C. to obtain a polyamic acid solution B. After being cooled to room temperature (23° C.), the polyamic acid solution B was applied onto a SUS foil (thickness 38 μm) to a thickness of 50 μm after drying, and dried at 90° C. for 20 min to obtain a support B with polyamic acid. A heat treatment was performed on the support B with polyamic acid at 300° C. for 2 hr under a nitrogen atmosphere to form a polyimide film (a thermally-detachable sheet) having a thickness of 50 μm, and a support B with a thermally-detachable sheet was obtained.

### Example 3

In an atmosphere under a nitrogen air flow, 13.37 g of polyetherdiamine (manufactured by Huntsman International LLC., D-400, molecular weight:422.6), 2.85 g of 4,4′-diaminodiphenylether (DDE, molecular weight:200.2), and 10.00 g of pyromellitic dianhydride (PMDA, molecular weight: 218.1) were mixed in 104.86 g of N,N-dimethylacetamide (DMAc) and reacted at 70° C. to obtain a polyamic acid solution C. After being cooled to room temperature (23° C.), the polyamic acid solution C was applied onto an 8 inch glass wafer with a spin coater, and dried at 90° C. for 20 min to obtain a support C with polyamic acid. A heat treatment was performed on the support C with polyamic acid at 300° C. for 2 hr under a nitrogen atmosphere to form a polyimide film (a thermally-detachable sheet) having a thickness of 80 μm, and a support C with a thermally-detachable sheet was obtained.

### Comparative Example 1

In an atmosphere under a nitrogen air flow, 35 g of thermally expandable microsphere as a foaming agent (manufactured by Matsumoto Yushi-Seiyaku Co., Ltd., Microspheres F-50D, foaming onset temperature: 120° C.), 9.18 g of 4,4′-diaminodiphenylether (DDE, molecular weight:200.2), and 10.0 g of pyromellitic dianhydride (PMDA, molecular weight:218.1) were mixed in 364.42 g of N,N-dimethylacetamide (DMAc) and reacted at 70° C. to obtain a polyamic acid solution I. After being cooled to room temperature (23° C.), the polyamic acid solution I was applied onto the mirror surface of an 8 inch silicon wafer with a spin coater, and dried at 90° C. for 20 min to obtain a support I with polyamic acid. A heat treatment was performed on the support I with polyamic acid at 300° C. for 2 hr under a nitrogen atmosphere to form a polyimide film (a thermally-detachable sheet) having a thickness of 30 μm, and a support I with a thermally-detachable sheet was obtained.

(Measurement of the Shear Adhering Strength to a Silicon Wafer)

A 5 mm square (thickness 500 μm) silicon wafer chip was placed on a thermally-detachable sheet formed on a support (a silicon wafer, a SUS foil, or a glass wafer), and laminated under the condition of 60° C. and 10 mm/s. Then, the shear adhering strength of the thermally-detachable sheet to the silicon wafer chip was measured using a shear tester (manufactured by Nordson Corporation, Dage 4000). The shear test was performed in the following two conditions. The results are shown in Table 4. Further, the sample of Comparative Example 1 was not adhered to a silicon wafer chip. Therefore, the measurement was not performed.

<Condition 1 of the Shear Test>

Stage Temperature: 200° C.

Time from placement of the test piece on the stage until the start of measurement of the shear adhering strength:
1 min

Measurement Speed: 500 μm/s

Measurement Gap: 100 μm

<Condition 2 of the Shear Test>

Stage Temperature: 260° C.

Time from placement of the test piece on the stage until the start of measurement of the shear adhering strength:
3 min

Measurement Speed: 500 μm/s

Measurement Gap: 100 μm

(Measurement of the Weight Loss Rate when the Sheet is Soaked in an Aqueous Tetramethyl Ammonium Hydroxide Solution)

First, the support was peeled off from the support with a thermally-detachable sheet according to the examples and the comparative example. Next, the peeled thermally-detachable sheet was cut into 100 mm square, and its weight was measured. Then, the sheet was soaked in a 3% aqueous tetramethyl ammonium hydroxide solution (TMAH) at 23° C. for 5 min. After the sheet was washed thoroughly with water, it was dried at 150° C. for 30 min. After that, the weight was measured and regarded as the weight after soaking.

The weight loss rate was obtained from the following formula. The results are shown in Table 4. Further, the measurement of the sample of Comparative Example 1 was not performed.

(Weight loss rate (% by weight))=[1−((weight after soaking)/(weight before soaking))]×100

(Measurement of the Weight Loss Rate when the Sheet is Soaked in N-Methyl-2-Pyrrolidone)

First, the support was peeled off from the support with a thermally-detachable sheet according to the examples and the comparative example. Next, the peeled thermally-detachable sheet was cut into 100 mm square, and its weight was measured. Then, the sheet was soaked in N-methyl-2-pyrrolidone (NMP) at 50° C. for 60 sec. After the sheet was washed thoroughly with water, it was dried at 150° C. for 30 min. After that, the weight was measured and regarded as the weight after soaking.

The weight loss rate was obtained from the following formula. The results are shown in Table 4. Further, the measurement of the sample of Comparative Example 1 was not performed.

(Weight loss rate (% by weight))=[((weight after soaking)/(weight before soaking))−1]×100

(Evaluation of the Adhesive Residue)

First, the support was peeled off from the support with a thermally-detachable sheet according to the examples and the comparative example. Next, each of the thermally-detachable sheets of the examples and the comparative example was processed into a piece having a diameter of 6 inches, and was laminated to a wafer having a diameter of 8 inches under the condition of 60° C. and 10 mm/s. After that, the sheet was left for 1 min, and peeled off. The number of particles of 0.2 μm or more on the surface of the 8 inch wafer was measured using a particle counter (SFS 6200, manufactured by KLA-Tencor Corporation). The evaluation was performed by marking the case in which the increased amount of particles after peeling was less than 1,000 particles/6 inch wafer with respect to the amount before the sheet was laminated as O, and the case in which it was 1,000 particles/6 inch wafer or more as X. The results are shown in Table 4. Further, the sample of Comparative Example 1 was not adhered to a wafer. Therefore, the measurement was not performed.

(Peeling Temperature)

The thermally-detachable sheets of the examples and the comparative example were made into a size of 30 mm square, and a 10 mm square (thickness: 2 mm) glass was bonded onto the thermally-detachable sheets using a laminator. Using this sample, the temperature at which the glass is peeled off from the thermally-detachable sheet was confirmed by increasing the temperature under the condition of a temperature rise rate of 4° C./min and a measurement temperature of 20° C. to 350° C. with a high temperature observation apparatus (trade name: SK-5000) manufactured by SANYO SEIKO CO., LTD. The results are shown in Table 4. Further, the sample of Comparative Example 1 was not adhered to a glass. Therefore, the measurement was not performed.

(Gas Visual Temperature)

The thermally-detachable sheets of the examples and the comparative example were made into a size of 30 mm square, and a 10 mm square (thickness: 2 mm) glass was bonded onto the thermally-detachable sheets using a laminator. Using this sample, the temperature at which white smoke was generated was confirmed by increasing the temperature under the condition of a temperature rise rate of 4° C./min and a measurement temperature of 20° C. to 350° C. with a high temperature observation apparatus (trade name:SK-5000) manufactured by SANYO SEIKO CO., LTD. The results are shown in Table 4. Further, the sample of Comparative Example 1 was not adhered to a glass. Therefore, the measurement was not performed.

(Dynamic Hardness)

A load-unload test was performed on the thermally-detachable sheets of the examples at a load of 0.5 mN using a hardness meter (trade name: DUH-210) manufactured by Shimadzu Corporation and an indenter (trade name: Triangular 115, manufactured by Shimadzu Corporation) to perform the measurement of the dynamic hardness. The results are shown in Table 4. Further, the measurement of the sample of Comparative Example 1 was not performed.

TABLE 4

| | | | | Compar- |
|---|---|---|---|---|
| | Exam- | Exam- | Exam- | ative |
| | ple 1 | ple 2 | ple 3 | Example 1 |
| Shear Adhering Strength | 0.89 | 1.87 | 15.06 | — |
| at 200° C. (kg/5 × 5 mm) | | | | |
| Shear Adhering Strength | 0.20 | 0.11 | 0.08 | — |
| at 260° C. (kg/5 × 5 mm) | | | | |
| TMAH Weight Loss Rate | 0.70 | 0.42 | 0.24 | — |
| (% by weight) | | | | |
| NMP Weight Loss Rate | 1.28 | 1.55 | 1.23 | — |
| (% by weight) | | | | |
| Evaluation of Adhesive Residue | ◯ | ◯ | ◯ | — |
| Peeling Temperature (° C.) | 202 | 281 | 274 | — |
| Gas Visual Temperature (° C.) | 243 | 238 | 262 | — |
| Dynamic Hardness | 3.7 | 2.1 | 1.1 | — |

### Fifth Aspect of the Present Invention

Each of the following examples and the like corresponds to the thermally-detachable sheet according to the fifth aspect of the present invention.

### Example 1

In an atmosphere under a nitrogen air flow, 10.66 g of polyetherdiamine (manufactured by Huntsman International LLC., D-400, molecular weight:422.6), 4.13 g of 4,4′-diaminodiphenylether (DDE, molecular weight:200.2), and 10.0 g of pyromellitic dianhydride (PMDA, molecular weight:218.1) were mixed in 99.16 g of N,N-dimethylacetamide (DMAc) and reacted at 70° C. to obtain a polyamic acid solution A. After being cooled to room temperature (23° C.), the polyamic acid solution A was applied onto the mirror surface of an 8 inch silicon wafer with a spin coater, and dried at 90° C. for 20 min to obtain a support A with polyamic acid. A heat treatment was performed on the support A with polyamic acid at 300° C. for 4 hr under a nitrogen atmosphere (oxygen concentration: 100 ppm or less) to form a polyimide film (a thermally-detachable sheet) having a thickness of 30 μm, and a support A with a thermally-detachable sheet was obtained. Further, the imidization rate of the thermally-detachable sheet according to Example 1 was 99.9%.

### Example 2

In an atmosphere under a nitrogen air flow, 14.86 g of an aromatic diamine oligomer (manufactured by IHARA CHEMICAL INDUSTRY CO., LTD., ELASMER 1000, molecular weight: 1229.7), 6.76 g of 4,4′-diaminodiphenylether (DDE, molecular weight: 200.2), and 10.0 g of pyromellitic dianhydride (PMDA, molecular weight: 218.1) were mixed in 67.41 g of N,N-dimethylacetamide (DMAc) and reacted at 70° C. to obtain a support B with polyamic acid B. After being cooled to room temperature (23° C.), the polyamic acid solution B was applied onto a SUS foil (thickness 38 μm) to a thickness of 50 μm after drying, and dried at 90° C. for 20 min to obtain a support B with polyamic acid. A heat treatment was performed on the support B with polyamic acid at 300° C. for 2 hr under a nitrogen atmosphere (oxygen concentration: 100 ppm or less) to form a polyimide film (a thermally-detachable sheet) having a thickness of 50 μm, and a support B with a thermally-detachable sheet was obtained. Further, the imidization rate of the thermally-detachable sheet according to Example 2 was 90%.

### Example 3

In an atmosphere under a nitrogen air flow, 18.98 g of polyetherdiamine (manufactured by Huntsman International LLC., D-4000, molecular weight: 4023.5), 8.24 g of 4,4′-diaminodiphenylether (DDE, molecular weight: 200.2), and 10.0 g of pyromellitic dianhydride (PMDA, molecular weight: 218.1) were mixed in 148.87 g of N,N-dimethylacetamide (DMAc) and reacted at 70° C. to obtain a polyamic acid solution C. After being cooled to room temperature (23° C.), the polyamic acid solution C was applied onto a SUS foil (thickness 38 μm) to a thickness of 50 μm after drying, and dried at 90° C. for 20 min to obtain a support C with polyamic acid. A heat treatment was performed on the support C with polyamic acid at 250° C. for 1.5 hr under a nitrogen atmosphere (oxygen concentration: 100 ppm or less) to form a polyimide film (a thermally-detachable sheet) having a thickness of 50 μm, and a support C with a thermally-detachable sheet was obtained. Further, the imidization rate of the thermally-detachable sheet according to Example 3 was 80.5%.

### Comparative Example 1

In an atmosphere under a nitrogen air flow, 9.18 g of 4,4′-diaminodiphenylether (DDE, molecular weight: 200.2) and 10.0 g of pyromellitic dianhydride (PMDA, molecular weight: 218.1) were mixed in 364.42 g of N,N-dimethylacetamide (DMAc) and reacted at 70° C. to obtain a polyamic acid solution I. After being cooled to room temperature (23° C.), the polyamic acid solution I was applied onto the mirror surface of an 8 inch silicon wafer with a spin coater, and dried at 90° C. for 20 min to obtain a support I with polyamic acid. A heat treatment was performed on the support I with polyamic acid at 300° C. for 2 hr under a nitrogen atmosphere (oxygen concentration: 100 ppm or less) to form a polyimide film (a thermally-detachable sheet) having a thickness of 30 μm, and a support I with a thermally-detachable sheet was obtained. Further, the imidization rate of the thermally-detachable sheet according to Comparative Example 1 was 75%.

The imidization rate of the examples and the comparative example was obtained by measuring a peak intensity of an imide group using 1H-NMR (proton nuclear magnetic resonance, LA400 manufactured by JEOL Ltd.). Specifically, a solution (a solution containing polyamic acid) for manufacturing the thermally-detachable sheet is applied and dried (drying condition: at 90° C. for 20 min), and the imidization is performed in the imidization condition described in the examples and the comparative example. In this state, a peak area A originated from an O—R proton (a peak area originated from an O—R proton in a state in which a diamine of polyamic acid and an acid anhydride are not ring-closed) and a peak area B originated from an imide group N—R proton (a peak area originated from an N—R proton in a state in which a diamine of polyamic acid and an acid anhydride are ring-closed) were obtained, and the imidization rate (%) was obtained from the formula (2).

[(B)/(A+B)]×100(%) Formula (2):

(Measurement of the Thermal Curing Rate)

The thermal curing rate was obtained as follows using a differential scanning calorimeter manufactured by Seiko Instruments Inc., trade name “DSC 6220”.

Specifically, the amount of heat generation (the total amount of heat generation) was measured when the temperature was increased to 500° C. (the temperature at which the thermal curing reaction was assumed to be thoroughly completed) from room temperature (23° C.) under the condition of a temperature rise rate of 10° C./min using a thermally-detachable sheet obtained by applying a solution (a solution containing polyamic acid) for manufacturing a thermally-detachable sheet according to the examples and the comparative example and drying the solution (condition: at 90° C. for 10 min). Further, the amount of heat generation (the amount of heat generation after the thermally-detachable sheet was manufactured) was measured when the temperature was increased to 500° C. (the temperature at which the thermal curing reaction was assumed to be thoroughly completed) from room temperature (23° C.) under the condition of a temperature rise rate of 10° C./min using a thermally-detachable sheet in which the manufacturing process was completed as the thermally-detachable sheet according to the examples and the comparative example. After that, the thermal curing rate was obtained from the following formula (1).

[1−((Amount of heat generation after the thermally-detachable sheet is manufactured)/(Total amount of heat generation))]×100(%) Formula (1):

Further, the amount of heat generation of reaction in a temperature range of ±5° C. of the peak temperature of heat of reaction that was measured by a differential scanning calorimeter was used for the amount of heat generation.

The results are shown in Table 5.

(Measurement of the Shear Adhering Strength to a Silicon Wafer)

A 5 mm square (thickness 500 μm) silicon wafer chip was placed on a thermally-detachable sheet formed on a support (a silicon wafer, a SUS foil, or a glass wafer), and laminated under the condition of 60° C. and 10 mm/s. Then, the shear adhering strength of the thermally-detachable sheet to the silicon wafer chip was measured using a shear tester (manufactured by Nordson Corporation, Dage 4000). The shear test was performed in the following two conditions. The results are shown in Table 5.

<Condition 1 of the Shear Test>

Stage Temperature: 200° C.

Time from placement of the test piece on the stage until the start of measurement of the shear adhering strength:
1 min

Measurement Speed: 500 μm/s

Measurement Gap: 100 μm

<Condition 2 of the Shear Test>

Stage Temperature: 260° C.

Time from placement of the test piece on the stage until the start of measurement of the shear adhering strength:
3 min

Measurement Speed: 500 μm/s

Measurement Gap: 100 μm

(Measurement of the Weight Loss Rate when the Sheet is Soaked in an Aqueous Tetramethyl Ammonium Hydroxide Solution)

First, the support was peeled off from the support with a thermally-detachable sheet according to the examples and the comparative example. Next, the peeled thermally-detachable sheet was cut into 100 mm square, and its weight was measured. Then, the sheet was soaked in a 3% by weight aqueous tetramethyl ammonium hydroxide solution (TMAH) at 23° C. for 5 min. After the sheet was washed thoroughly with water, it was dried at 150° C. for 30 min. After that, the weight was measured and regarded as the weight after soaking.

The weight loss rate was obtained from the following formula. The results are shown in Table 5.

(Weight loss rate (% by weight))=[1−((weight after soaking)/(weight before soaking))]×100

(Evaluation of the Adhesive Residue)

First, the support was peeled off from the support with a thermally-detachable sheet according to the examples and the comparative example. Next, each of the thermally-detachable sheets of the examples and the comparative example was processed into a piece having a diameter of 6 inches, and was laminated to a wafer having a diameter of 8 inches under the condition of 60° C. and 10 mm/s. After that, the sheet was left for 1 min, and peeled off. The number of particles of 0.2 μm or more on the surface of the 8 inch wafer was measured using a particle counter (SFS 6200, manufactured by KLA-Tencor Corporation). The evaluation was performed by marking the case in which the increased amount of particles after peeling was less than 1,000 particles/6 inch wafer with respect to the amount before the sheet was laminated as O, and the case in which it was 1,000 particles/6 inch wafer or more as X. The results are shown in Table 5.

(Peeling Temperature)

The thermally-detachable sheets of the examples and the comparative example were made into a size of 30 mm square, and a 10 mm square (thickness: 2 mm) glass was bonded onto the thermally-detachable sheets using a laminator. Using this sample, the temperature at which the glass is peeled off from the thermally-detachable sheet was confirmed by increasing the temperature under the condition of a temperature rise rate of 4° C./min and a measurement temperature of 20° C. to 350° C. with a high temperature observation apparatus (trade name: SK-5000) manufactured by SANYO SEIKO CO., LTD. The results are shown in Table 5.

(Gas Visual Temperature)

The thermally-detachable sheets of the examples and the comparative example were made into a size of 30 mm square, and a 10 mm square (thickness: 2 mm) glass was bonded onto the thermally-detachable sheets using a laminator. Using this sample, the temperature at which white smoke was generated was confirmed by increasing the temperature under the condition of a temperature rise rate of 4° C./min and a measurement temperature of 20° C. to 350° C. with a high temperature observation apparatus (trade name:SK-5000) manufactured by SANYO SEIKO CO., LTD. The results are shown in Table 5.

(Dynamic Hardness)

A load-unload test was performed on the thermally-detachable sheets of the examples at a load of 0.5 mN using a hardness meter (trade name: DUH-210) manufactured by Shimadzu Corporation and an indenter (trade name: Triangular 115, manufactured by Shimadzu Corporation) to perform the measurement of the dynamic hardness. The results are shown in Table 5.

TABLE 5

| | | | | Compar- |
|---|---|---|---|---|
| | Exam- | Exam- | Exam- | ative |
| | ple 1 | ple 2 | ple 3 | Example 1 |
| Thermal Curing Rate (%) | 99.9 | 91.5 | 81 | 78 |
| Shear Adhering Strength | 2.03 | 1.63 | 1.90 | — |
| at 200° C. (kg/5 × 5 mm) | | | | |
| Shear Adhering Strength | 0.10 | 0.13 | 0.08 | — |
| at 260° C. (kg/5 × 5 mm) | | | | |
| TMAH Weight Loss Rate | 0.22 | 0.25 | 0.57 | — |
| (% by weight) | | | | |
| NMP Weight Loss Rate | 1.04 | 1.14 | 1.84 | — |
| (% by weight) | | | | |
| Evaluation of Adhesive Residue | ◯ | ◯ | ◯ | — |
| Peeling Temperature (° C.) | 320 | 339 | 243 | — |
| Gas Visual Temperature (° C.) | 273 | 293 | 243 | — |
| Surface Hardness (GPa) | 3.3 | 3.6 | 0.9 | — |
| Dynamic Hardness | 2.9 | 4.2 | 2.6 | — |

### Sixth Aspect of the Present Invention

Each of the following examples and the like corresponds to the thermally-detachable sheet according to the sixth aspect of the present invention.

### Example 1

In an atmosphere under a nitrogen air flow, 13.45 g of polyetherdiamine (manufactured by Huntsman International LLC., D-2000, molecular weight: 1990.8), 7.83 g of 4,4′-diaminodiphenylether (DDE, molecular weight: 200.2), and 10.0 g of pyromellitic dianhydride (PMDA, molecular weight: 218.1) were mixed in 125.10 g of N,N-dimethylacetamide (DMAc) and reacted at 70° C. to obtain a polyamic acid solution A. After being cooled to room temperature (23° C.), the polyamic acid solution A was applied onto the mirror surface of an 8 inch silicon wafer with a spin coater, and dried at 90° C. for 20 min to obtain a support A with polyamic acid. A heat treatment was performed on the support A with polyamic acid at 300° C. for 2 hr under a nitrogen atmosphere to form a polyimide film (a thermally-detachable sheet) having a thickness of 30 μm, and a support A with a thermally-detachable sheet was obtained.

Further, the compounding ratio of an acid anhydride (pyromellitic dianhydride), a diamine having an ether structure (polyetherdiamine), and another diamine having no ether structure (DDE) in the polyamic acid solution A was as follows by mole ratio.

(Acid anhydride): (Diamine having an ether structure): (Another diamine have no ether structure)=100:14.7:85.3

### Example 2

In an atmosphere under a nitrogen air flow, 18.98 g of polyetherdiamine (manufactured by Huntsman International LLC., D-4000, molecular weight: 4023.5), 8.24 g of 4,4′-diaminodiphenylether (DDE, molecular weight: 200.2), and 10.0 g of pyromellitic dianhydride (PMDA, molecular weight: 218.1) were mixed in 148.87 g of N,N-dimethylacetamide (DMAc) and reacted at 70° C. to obtain a polyamic acid solution B. After being cooled to room temperature (23° C.), the polyamic acid solution B was applied onto a SUS foil (thickness 38 μm) to a thickness of 50 μm after drying, and dried at 90° C. for 20 min to obtain a support B with polyamic acid. A heat treatment was performed on the support B with polyamic acid at 300° C. for 2 hr under a nitrogen atmosphere to form a polyimide film (a thermally-detachable sheet) having a thickness of 50 μm, and a support B with a thermally-detachable sheet was obtained.

Further, the compounding ratio of an acid anhydride (pyromellitic dianhydride), a diamine having an ether structure (polyetherdiamine), and another diamine having no ether structure (DDE) in the polyamic acid solution B was as follows by mole ratio.

(Acid anhydride): (Diamine having an ether structure): (Another diamine have no ether structure)=100:10.3:89.7

### Example 3

In an atmosphere under a nitrogen air flow, 13.37 g of polyetherdiamine (manufactured by Huntsman International LLC., D-400, molecular weight:422.6), 2.85 g of 4,4′-diaminodiphenylether (DDE, molecular weight:200.2), and 10.0 g of pyromellitic dianhydride (PMDA, molecular weight:218.1) were mixed in 104.86 g of N, N-dimethylacetamide (DMAc) and reacted at 70° C. to obtain a polyamic acid solution C. After being cooled to room temperature (23° C.), the polyamic acid solution C was applied onto an 8 inch glass wafer with a spin coater, and dried at 90° C. for 20 min to obtain a support C with polyamic acid. A heat treatment was performed on the support C with polyamic acid at 300° C. for 2 hr under a nitrogen atmosphere to form a polyimide film (a thermally-detachable sheet) having a thickness of 80 μm, and a support C with a thermally-detachable sheet was obtained.

Further, the compounding ratio of an acid anhydride (pyromellitic dianhydride), a diamine having an ether structure (polyetherdiamine), and another diamine having no ether structure (DDE) in the polyamic acid solution C was as follows by mole ratio.

(Acid anhydride): (Diamine having an ether structure): (Another diamine have no ether structure)=100:69.0:31.0

### Comparative Example 1

In an atmosphere under a nitrogen air flow, 9.18 g of 4,4′-diaminodiphenylether (DDE, molecular weight: 200.2) and 10.0 g of pyromellitic dianhydride (PMDA, molecular weight: 218.1) were mixed in 364.42 g of N,N-dimethylacetamide (DMAc) and reacted at 70° C. to obtain a polyamic acid solution I. After being cooled to room temperature (23° C.), the polyamic acid solution I was applied onto the mirror surface of an 8 inch silicon wafer with a spin coater, and dried at 90° C. for 20 min to obtain a support I with polyamic acid. A heat treatment was performed on the support I with polyamic acid at 300° C. for 2 hr under a nitrogen atmosphere to form a polyimide film (a thermally-detachable sheet) having a thickness of 30 μm, and a support I with a thermally-detachable sheet was obtained.

Further, the compounding ratio of an acid anhydride (pyromellitic dianhydride), a diamine having an ether structure (polyetherdiamine), and another diamine having no ether structure (DDE) in the polyamic acid solution I was as follows by mole ratio.

(Acid anhydride): (Diamine having an ether structure): (Another diamine have no ether structure)=100:0:100

(Measurement of the Shear Adhering Strength to a Silicon Wafer)

A 5 mm square (thickness 500 μm) silicon wafer chip was placed on a thermally-detachable sheet formed on a support, and laminated under the condition of 60° C. and 10 mm/s. Then, the shear adhering strength of the thermally-detachable sheet to the silicon wafer chip was measured using a shear tester (manufactured by Nordson Corporation, Dage 4000). The shear test was performed in the following two conditions. The results are shown in Table 6. Further, the sample of Comparative Example 1 was not adhered to a silicon wafer chip. Therefore, the measurement was not performed.

<Condition 1 of the Shear Test>

Stage Temperature: 200° C.

Time from placement of the test piece on the stage until the start of measurement of the shear adhering strength:
1 min

Measurement Speed: 500 μm/s

Measurement Gap: 100 μm

<Condition 2 of the Shear Test>

Stage Temperature: 260° C.

Time from placement of the test piece on the stage until the start of measurement of the shear adhering strength:
3 min

Measurement Speed 500 μm/s

Measurement Gap: 100 μm

(Measurement of the Weight Loss Rate when the Sheet is Soaked in an Aqueous Tetramethyl Ammonium Hydroxide Solution)

First, the support was peeled off from the support with a thermally-detachable sheet according to the examples and the comparative example. Next, the peeled thermally-detachable sheet was cut into 100 mm square, and its weight was measured. Then, the sheet was soaked in a 3% aqueous tetramethyl ammonium hydroxide solution (TMAH) at 23° C. for 5 min. After the sheet was washed thoroughly with water, it was dried at 150° C. for 30 min. After that, the weight was measured and regarded as the weight after soaking.

The weight loss rate was obtained from the following formula. The results are shown in Table 6. Further, the measurement of the sample of Comparative Example 1 was not performed.

(Weight loss rate (% by weight))=[1−((weight after soaking)/(weight before soaking))]×100

(Measurement of the Weight Loss Rate when the Sheet is Soaked in N-Methyl-2-Pyrrolidone)

First, the support was peeled off from the support with a thermally-detachable sheet according to the examples and the comparative example. Next, the peeled thermally-detachable sheet was cut into 100 mm square, and its weight was measured. Then, the sheet was soaked in N-methyl-2-pyrrolidone (NMP) at 50° C. for 60 sec. After the sheet was washed thoroughly with water, it was dried at 150° C. for 30 min. After that, the weight was measured and regarded as the weight after soaking.

The weight loss rate was obtained from the following formula. The results are shown in Table 6. Further, the measurement of the sample of Comparative Example 1 was not performed.

(Weight loss rate (% by weight))=[((weight after soaking)/(weight before soaking))−1]×100

(Evaluation of the Adhesive Residue)

First, the support was peeled off from the support with a thermally-detachable sheet according to the examples and the comparative example. Next, each of the thermally-detachable sheets of the examples and the comparative example was processed into a piece having a diameter of 6 inches, and was laminated to a wafer having a diameter of 8 inches under the condition of 60° C. and 10 mm/s. After that, the sheet was left for 1 min, and peeled off. The number of particles of 0.2 μm or more on the surface of the 8 inch wafer was measured using a particle counter (SFS 6200, manufactured by KLA-Tencor Corporation). The evaluation was performed by marking the case in which the increased amount of particles after peeling was less than 1,000 particles/6 inch wafer with respect to the amount before the sheet was laminated as O, and the case in which it was 1,000 particles/6 inch wafer or more as X. The results are shown in Table 6. Further, the sample of Comparative Example 1 was not adhered to a wafer. Therefore, the measurement was not performed.

(Peeling Temperature)

The thermally-detachable sheets of the examples and the comparative example were made into a size of 30 mm square, and a 10 mm square (thickness: 2 mm) glass was bonded onto the thermally-detachable sheets using a laminator. Using this sample, the temperature at which the glass is peeled off from the thermally-detachable sheet was confirmed by increasing the temperature under the condition of a temperature rise rate of 4° C./min and a measurement temperature of 20° C. to 350° C. with a high temperature observation apparatus (trade name: SK-5000) manufactured by SANYO SEIKO CO., LTD. The results are shown in Table 6. Further, the sample of Comparative Example 1 was not adhered to a glass. Therefore, the measurement was not performed.

(Gas Visual Temperature)

The thermally-detachable sheets of the examples and the comparative example were made into a size of 30 mm square, and a 10 mm square (thickness: 2 mm) glass was bonded onto the thermally-detachable sheets using a laminator. Using this sample, the temperature at which white smoke was generated was confirmed by increasing the temperature under the condition of a temperature rise rate of 4° C./min and a measurement temperature of 20° C. to 350° C. with a high temperature observation apparatus (trade name:SK-5000) manufactured by SANYO SEIKO CO., LTD. The results are shown in Table 6. Further, the sample of Comparative Example 1 was not adhered to a glass. Therefore, the measurement was not performed.

(Surface Hardness)

A load-unload test was performed on the thermally-detachable sheets of the examples and the comparative example at a load of 0.5 mN using a hardness meter (trade name: DUH-210) manufactured by Shimadzu Corporation to perform the measurement of the surface hardness. The results are shown in Table 6. Further, the measurement of the sample of Comparative Example 1 was not performed.

(Dynamic Hardness)

A load-unload test was performed on the thermally-detachable sheets of the examples and the comparative example at a load of 0.5 mN using a hardness meter (trade name: DUH-210) manufactured by Shimadzu Corporation and an indenter (trade name: Triangular 115, manufactured by Shimadzu Corporation) to perform the measurement of the dynamic hardness. The results are shown in Table 6. Further, the measurement of the sample of Comparative Example 1 was not performed.

TABLE 6

| | | | | Compar- |
|---|---|---|---|---|
| | Exam- | Exam- | Exam- | ative |
| | ple 1 | ple 2 | ple 3 | Example 1 |
| Shear Adhering Strength | 1.09 | 1.90 | 15.06 | — |
| at 200° C. (kg/5 × 5 mm) | | | | |
| Shear Adhering Strength | 0.08 | 0.08 | 0.08 | — |
| at 260° C. (kg/5 × 5 mm) | | | | |
| TMAH Weight Loss Rate | 0.42 | 0.57 | 0.24 | — |
| (% by weight) | | | | |
| NMP Weight Loss Rate | 1.33 | 1.84 | 1.23 | — |
| (% by weight) | | | | |
| Evaluation of Adhesive Residue | ◯ | ◯ | ◯ | — |
| Peeling Temperature (° C.) | 248 | 243 | 274 | — |
| Gas Visual Temperature (° C.) | 243 | 243 | 262 | — |
| Surface Hardness (GPa) | 1.5 | 0.9 | 0.7 | — |
| Dynamic Hardness | 2.8 | 2.6 | 1.1 | — |

### Seventh Aspect of the Present Invention

Each of the following examples and the like corresponds to the thermally-detachable sheet according to the seventh aspect of the present invention.

### Example 1

In an atmosphere under a nitrogen air flow, 12.89 g of an aromatic diamine oligomer (manufactured by IHARA CHEMICAL INDUSTRY CO., LTD., ELASMER 1000, molecular weight: 1229.7), 7.08 g of 4,4′-diaminodiphenylether (DDE, molecular weight: 200.2), and 10.0 g of pyromellitic dianhydride (PMDA) were mixed in 68.33 g of N,N-dimethylacetamide (DMAc) and reacted at 70° C. to obtain a polyamic acid solution A. After being cooled to room temperature (23° C.), the polyamic acid solution A was applied onto the mirror surface of an 8 inch silicon wafer with a spin coater, and dried at 90° C. for 20 min to obtain a support A with polyamic acid. A heat treatment was performed on the support A with polyamic acid at 300° C. for 2 hr under a nitrogen atmosphere to form a polyimide film (a thermally-detachable sheet) having a thickness of 30 μm, and a support A with a thermally-detachable sheet was obtained.

### Example 2

In an atmosphere under a nitrogen air flow, 16.29 g of polyetherdiamine (manufactured by Huntsman International LLC., D-400, molecular weight: 422.6), 8.37 g of 4,4′-diaminodiphenylether (DDE, molecular weight: 200.2), and 10.0 g of pyromellitic dianhydride (PMDA) were mixed in 138.6 g of N,N-dimethylacetamide (DMAc) and reacted at 70° C. to obtain a polyamic acid solution B. After being cooled to room temperature (23° C.), the polyamic acid solution B was applied onto the mirror surface of an 8 inch silicon wafer with a spin coater, and dried at 120° C. for 10 min to obtain a support B with polyamic acid. A heat treatment was performed on the support B with polyamic acid at 300° C. for 2 hr under a nitrogen atmosphere to form a polyimide film (a thermally-detachable sheet) having a thickness of 10 μm, and a support B with a thermally-detachable sheet was obtained.

### Example 3

In an atmosphere under a nitrogen air flow, 18.07 g of polyetherdiamine (manufactured by Huntsman International LLC., D-2000, molecular weight: 1990.8), 7.36 g of 4,4′-diaminodiphenylether (DDE, molecular weight: 200.2), and 10.0 g of pyromellitic dianhydride (PMDA) were mixed in 141.7 g of N-methyl-2-pyrrolidone (NMP) and reacted at 70° C. to obtain a polyamic acid solution C. After being cooled to room temperature (23° C.), the polyamic acid solution C was applied onto the mirror surface of an 8 inch silicon wafer with a spin coater, and dried at 100° C. for 12 min to obtain a support C with polyamic acid. A heat treatment was performed on the support C with polyamic acid at 300° C. for 2 hr under a nitrogen atmosphere to form a polyimide film (a thermally-detachable sheet) having a thickness of 15 μm, and a support C with a thermally-detachable sheet was obtained.

### Comparative Example 1

In an atmosphere under a nitrogen air flow, 9.18 g of 4,4′-diaminodiphenylether (DDE, molecular weight: 200.2) and 10.0 g of pyromellitic dianhydride (PMDA) were mixed in 364.4 g of N,N-dimethylacetamide (DMAc) and reacted at 70° C. to obtain a polyamic acid solution D. After being cooled to room temperature (23° C.), the polyamic acid solution D was applied onto the mirror surface of an 8 inch silicon wafer with a spin coater, and dried at 150° C. for 10 min to obtain a support D with polyamic acid. A heat treatment was performed on the support D with polyamic acid at 400° C. for 2 hr under a nitrogen atmosphere to form a polyimide film (a thermally-detachable sheet) having a thickness of 10 μm, and a support D with a thermally-detachable sheet was obtained.

### (Measurement of the Shear Adhering Strength to a Silicon Wafer)

A 5 mm square (thickness 500 μm) silicon wafer chip was placed on a thermally-detachable sheet formed on a support (a silicon wafer), and laminated under the condition of 60° C. and 10 mm/s. Then, the shear adhering strength of the thermally-detachable sheet to the silicon wafer chip was measured using a shear tester (manufactured by Nordson Corporation, Dage 4000). The shear test was performed in the following two conditions. The results are shown in Table 7. Further, the evaluation was performed by placing the shear tester in a glove box to control the oxygen concentration.

<Condition 1 of the Shear Test>

Oxygen Concentration: 55 ppm

Total pressure in the atmosphere:
1 atmosphere (101,325 Pa)

Stage Temperature: 240° C.

Time from placement of the test piece on the stage until the start of measurement of the shear adhering strength:
5 min

Measurement Speed: 500 μm/s

Measurement Gap: 100 μm

<Condition 2 of the Shear Test>

Oxygen Concentration: 95 ppm

Total pressure in the atmosphere:
10 torr (1,333.22 Pa)
(N₂ substitution)

Stage Temperature: 300° C.

Time from placement of the test piece on the stage until the start of measurement of the shear adhering strength:
1 min

Measurement Speed: 500 μm/s

Measurement Gap: 100 μm

<Condition 3 of the Shear Test>

Oxygen Concentration: 21 vol %

Total pressure in the atmosphere:
1 atmosphere (101,325 Pa)

Stage Temperature: 200° C.

Time from placement of the test piece on the stage until the start of measurement of the shear adhering strength:
30 min

Measurement Speed: 500 μm/s

Measurement Gap: 100 μm

(Measurement of the Weight Loss Rate when the Sheet is Soaked in an Aqueous Tetramethyl Ammonium Hydroxide Solution)

First, the support was peeled off from the support with a thermally-detachable sheet according to the examples and the comparative example. Next, the peeled thermally-detachable sheet was cut into 100 mm square, and its weight was measured. Then, the sheet was soaked in a 3% by weight aqueous tetramethyl ammonium hydroxide solution (TMAH) at 23° C. for 5 min. After the sheet was washed thoroughly with water, it was dried at 150° C. for 30 min. After that, the weight was measured and regarded as the weight after soaking.

The weight loss rate was obtained from the following formula. The results are shown in Table 7.

(Weight loss rate (% by weight))=[1−((weight after soaking)/(weight before soaking))]×100

(Evaluation of the Adhesive Residue)

First, the support was peeled off from the support with a thermally-detachable sheet according to the examples and the comparative example. Next, each of the thermally-detachable sheets of the examples and the comparative example was processed into a piece having a diameter of 6 inches, and was laminated to a wafer having a diameter of 8 inches under the condition of 60° C. and 10 mm/s. After that, the sheet was left for 1 min, and peeled off. The number of particles of 0.2 μm or more on the surface of the 8 inch wafer was measured using a particle counter (SFS 6200, manufactured by KLA-Tencor Corporation). The evaluation was performed by marking the case in which the increased amount of particles after peeling was less than 1,000 particles/6 inch wafer with respect to the amount before the sheet was laminated as O, and the case in which it was 1,000 particles/6 inch wafer or more as X. The results are shown in Table 7.

(Peeling Temperature)

The thermally-detachable sheets of the examples and the comparative example were made into a size of 30 mm square, and a 10 mm square (thickness: 2 mm) glass was bonded onto the thermally-detachable sheets using a laminator. Using this sample, the temperature at which the glass is peeled off from the thermally-detachable sheet was confirmed by increasing the temperature under the condition of a temperature rise rate of 4° C./min and a measurement temperature of 20° C. to 350° C. with a high temperature observation apparatus (trade name: SK-5000) manufactured by SANYO SEIKO CO., LTD. The results are shown in Table 7.

(Gas Visual Temperature)

The thermally-detachable sheets of the examples and the comparative example were made into a size of 30 mm square, and a 10 mm square (thickness: 2 mm) glass was bonded onto the thermally-detachable sheets using a laminator. Using this sample, the temperature at which white smoke was generated was confirmed by increasing the temperature under the condition of a temperature rise rate of 4° C./min and a measurement temperature of 20° C. to 350° C. with a high temperature observation apparatus (trade name:SK-5000) manufactured by SANYO SEIKO CO., LTD. The results are shown in Table 7.

(Dynamic Hardness)

A load-unload test was performed on the thermally-detachable sheets of the examples at a load of 0.5 mN using a hardness meter (trade name: DUH-210) manufactured by Shimadzu Corporation and an indenter (trade name: Triangular 115, manufactured by Shimadzu Corporation) to perform the measurement of the dynamic hardness. The results are shown in Table 7.

### [Table 7]

TABLE 7

| | | | | Compar- |
|---|---|---|---|---|
| | Example | Example | Example | ative |
| | 1 | 2 | 3 | Example 1 |
| Shear Adhering Strength | 12.00 | 20.00 | 9.80 | — |
| (kg/5 × 5 mm) in Condition 1 | | | | |
| Shear Adhering Strength | 9.50 | 15.00 | 9.50 | — |
| (kg/5 × 5 mm) in Condition 2 | | | | |
| Shear Adhering Strength | 0.15 | 0.12 | 0.05 | — |
| (kg/5 × 5 mm) in Condition 3 | | | | |
| TMAH Weight Loss Rate | 0.01 | 0.11 | 0.09 | 0 |
| (% by weight) | | | | |
| Evaluation of Adhesive | ○ | ○ | ○ | — |
| Residue | | | | |
| Peeling Temperature (° C.) | 255 | 280 | 220 | — |
| Gas Visual Temperature (° C.) | 240 | 240 | 240 | — |
| Dynamic Hardness | 3.9 | 4.2 | 3.9 | 18 |

### DESCRIPTION OF REFERENCE SIGNS

1 Support
2 Wiring Circuit Board
20a Base Insulating Layer
20b Adhesive Layer
21 Conductor Portion for Connection
22 Conduction Portion for External Connection
23 Conductor Layer
23a Seed Film
24 Conductive Path
25 Conductive Path
211 Metal Film
3 Semiconductor Chip
31 Electrode
4 Semiconductor Device
5 Release Layer
r1 Resist
r2 Resist

1. A thermally-detachable sheet, wherein
the shear adhering strength of the thermally-detachable sheet to a silicon wafer at 200° C. after the sheet is kept at that temperature for 1 min is 0.25 kg/5×5 mm or more, and
the shear adhering strength of the thermally-detachable sheet to a silicon wafer at any temperature in a temperature range of more than 200° C. and 500° C. or less after the sheet is kept at that temperature for 3 min is less than 0.25 kg/5×5 mm.

2. The thermally-detachable sheet according to claim 1, wherein the dynamic hardness is 10 or less.

3. The thermally-detachable sheet according to claim 1, wherein the weight loss rate of the thermally-detachable sheet after the sheet is soaked in a 3% aqueous tetramethyl ammonium hydroxide solution for 5 min is less than 1% by weight.

4. The thermally-detachable sheet according to claim 1, wherein the increased amount of particles of 0.2 μm or more on a surface of a silicon wafer when the thermally-detachable sheet is bonded to the silicon wafer and then peeled off is less than 10,000 particles/6 inch wafer with respect to the amount before the sheet is bonded to the silicon wafer.

5. A thermally-detachable sheet with a support, wherein the thermally-detachable sheet according to claim 1 is provided on a support.
